(19) United States
(12) Patent Application Publication
(10) Pub. No.: US 2026/0085743 A1
(43) Pub. Date: Mar. 26, 2026

(54) INTERLOCKING RADIAL FACE DOG CLUTCH

(71) Applicant: DANA ITALIA S.R.L., Arco (IT)

(72) Inventors: Pier Paolo RINALDI, Arco (IT); Matteo DALLAPICCOLA, Trento (IT); Giacomo FAGGIANI, Rovereto (IT)

(21) Appl. No.: 18/893,181

(22) Filed: Sep. 23, 2024

(51) Int. Cl. F16D 11/00; F16D 48/02

(52) U.S. Cl. CPC F16H 3/083; B60K 17/06

(57) ABSTRACT

A transmission comprising: a hollow shaft comprising at least two sets of radial pass-through holes including a first set and a second set of radial pass-through holes; a plurality of gears arranged around the hollow shaft; a plurality of sliding keys configured to extend through the radial pass-through holes of the hollow shaft and engage in a plurality of recesses of a selected gear to engage and couple the selected gear; a plurality of sliding sleeve, where each of the sliding keys is interposed between two sliding sleeves, where the two sliding sleeves are spring-compressed and abut the sliding keys in such a way that only one gear is selected, therein realizing an interlock for the sliding keys; and a rod configured to translate coaxially to and along the hollow shaft, where the rod comprises a cam-shaped section configured to actuate the plurality of sliding keys of the selected gear.

### TECHNICAL FIELD

The present description relates to a system of a dog clutch comprising a hollow shaft housing a rod.

### BACKGROUND AND SUMMARY

Vehicles may have a transmission including a gear train with a plurality of gearsets of different ratios. The vehicle may be electrified, such as an all-electric vehicle (EV) or a hybrid vehicle. A gear shifting mechanism comprising one or more of a plurality of clutches may be used to select different speeds. Gear-shifting mechanism may be bulky, occupying substantial packing space of the transmission. Further, a device external to the shaft, referred to herein as an external device, may be included to reduce selection of more than one gear by the gear-shifting mechanism simultaneously.

The volume occupied by the gear-shifting mechanism can affect packaging space available for additional gears and the volume occupied by the transmission. The external device to reduce selection of more than one gear may be removed from the gear-shifting mechanism, reducing the packing space occupied by the gear-shifting mechanism. However, the gears of a gear train may slide along a shaft without the external device, particularly at high speed experienced in an electrified vehicle. Further, at high rotational speeds, selecting more than one gear at the same time may cause degradation to the selected gears, the shaft selectively coupled to the selected gears, and other components of the gear train.

The inventors herein have recognized these and other issues with such systems and have come up with a way to at least partially solve them. Thus disclosed is a transmission comprising: a hollow shaft comprising at least two sets of radial pass-through holes including a first set and a second set of radial pass-through holes; a plurality of gears arranged around the hollow shaft; a plurality of sliding keys configured to extend through the radial pass-through holes of the hollow shaft and engage in a plurality of recesses of a selected gear to engage and couple the selected gear; a plurality of sliding sleeve, where each of the sliding keys is interposed between two sliding sleeves, where the two sliding sleeves are spring-compressed and abut the sliding keys in such a way that only one gear is selected, therein realizing an interlock for the sliding keys; and a rod configured to translate coaxially to and along the hollow shaft, where the rod comprises a cam-shaped section configured to actuate the plurality of sliding keys of the selected gear.

The rod may be configured such as to reduce contact with and translation of the first sliding keys, the second sliding key, and sliding keys of other sets in a radial direction at the same time. Reducing contact therein reduces the selection of more than one gear simultaneously while preventing the use of the external device, such as an external device comprising a fork and a sleeve, to reduce selection between multiple gears. The lack of the external device may decrease the packing space of the dog clutch assembly and gear train, while increasing the volume and packing space available within the gearbox. This approach addresses these issues by providing a gear selection system that reduces the volume and packing space used by a gear train, and prevent and/or reduce erroneous gear selection.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle including a transmission and a gear selection assembly of the present disclosure.

FIG. 2 shows a sectional view of a dog clutch assembly comprising a hollow shaft with a rod.

FIG. 3 shows a sectional view of the dog clutch assembly.

FIG. 4 shows a side and sectional view of the dog clutch assembly.

FIG. 5A shows a side and sectional view of the rod of the dog clutch assembly in a first position.

FIG. 5B shows the side and sectional view of the rod of the dog clutch in a second position.

FIG. 5C shows the side and sectional view of the rod of the dog clutch in a third position.

FIG. 5D shows the side and sectional view of the rod of the dog clutch in a fourth position.

FIG. 6 shows a side and sectional view of the rod of the dog clutch in the first position.

FIG. 7A shows a side and sectional view of the rod of the dog clutch in the fourth position.

FIG. 7B shows the side and sectional view of the dog clutch in the fourth positon with a plurality of forces.

FIG. 8 shows a schematic of a dog clutch, a rod, and a gear of the present disclosure.

FIG. 9 shows a perspective and sectional view of the dog clutch, a gear, and a set of keys.

FIG. 10 shows a front and sectional view of the dog clutch, the gear, the keys, and a rod.

FIG. 11 shows a sectional view a sliding key of the present disclosure.

FIG. 12 shows a side and perspective view of a gear of the present disclosure.

### DETAILED DESCRIPTION

The following description relates a transmission of a driveline assembly, where the transmission comprises one or more dog clutch assemblies. Each dog clutch assembly comprises a hollow shaft comprising at least two sets of radial pass-through holes including a first set and a second set of radial pass-through holes. There may be a plurality of gears arrange around the shaft. Additionally, there are a plurality of sliding keys configured to extend through the pass-through holes of the shaft and engage in the recesses of a selected gear. The geometry of the keys and a plurality of features of a plurality of sliding sleeve, such as surfaces and/or other geometries of the sleeve, may realize an interlock. The interlock allows for one, more, or all keys of a set of keys to extend, being pushed radially outward to engage and rigidly couple with the selected gear. The interlock also locks the other keys of other sets of keys of the assembly in place. The locked keys may be translated at a reduced distance or may be prevented from translating in a radial direction from the shaft compared to the keys engaged with the selected gear. Said in another way, the sleeves and the geometry of the keys may realize interlock, preventing more than one key from extending radially outward to engage a gear and therein a transmission speed. By realizing interlock, more than one gear may be prevented from selectively coupling the shaft.

The dog clutch assembly includes the plurality of sliding sleeves, where each sliding key is interposed between two sliding sleeves that are spring-compressed. The plurality of sliding sleeves may be housed via the shaft. The dog clutch assembly includes a rod configured to translate coaxially to and along the shaft. The shaft of the dog clutch assembly houses the rod. The rod comprises a cam-shaped section configured to actuate the plurality of sliding keys of the selected gear. Two sliding sleeves are configured to abut each sliding key, and the cam-shaped section is configured to contact sets of sliding keys in such a way that only one gear may be selected. There may be at least two gears around the shaft with two sets of sliding keys, where each set of sliding keys may slide radially outward to engage a gear of the two gears and selectively couple the gear to the shaft. There may be at least two sets of radial pass-through holes, where the keys of each set of sliding keys are housed by and translatable through the two sets of radial pass-through holes. Likewise, there may be at least two sets of recesses, where each set of recesses are specific to each gear of the at least two gears.

The following description also relates to a dog clutch assembly of the present disclosure. The dog clutch assembly may be an example dog clutch assembly used in the transmission. The dog clutch assembly may selectively couple three gears to a shaft, while reducing the selective coupling of two or more gears to the shaft. The shaft may house the three sets of keys via three sets of slots, and a rod with a cam-shaped section. The cam-shaped section may contact and translate a set of keys radially outward to engage with a specific gear of the three gears. The cam-shaped section is configured to reduce contact with more than one set of keys at a time. The cam-shaped section may therein be configured to avoid engagement of more than one set of keys with a gear at a time.

The following description also relates to a method of selectively coupling gears via the dog clutch assembly, via translating the rod to different positions along a central axis of the shaft and the dog clutch assembly. The rod may be advanced via increasing pressure to a pressure cylinder or another pressure body responsible for actuating the rod. The rod may be retracted via decreasing pressure to the pressure cylinder or other pressure body responsible for actuating the rod. However, it is to be appreciated, that the rod may additionally or alternatively be actuated via electrical means, such as via pure electric actuation or electro-hydraulic actuation. The rod may therein be actuated via an electric machine, such as an electric motor. Gears may be selectively coupled or decoupled via advancing and retracting the rod to different positions along the central axis.

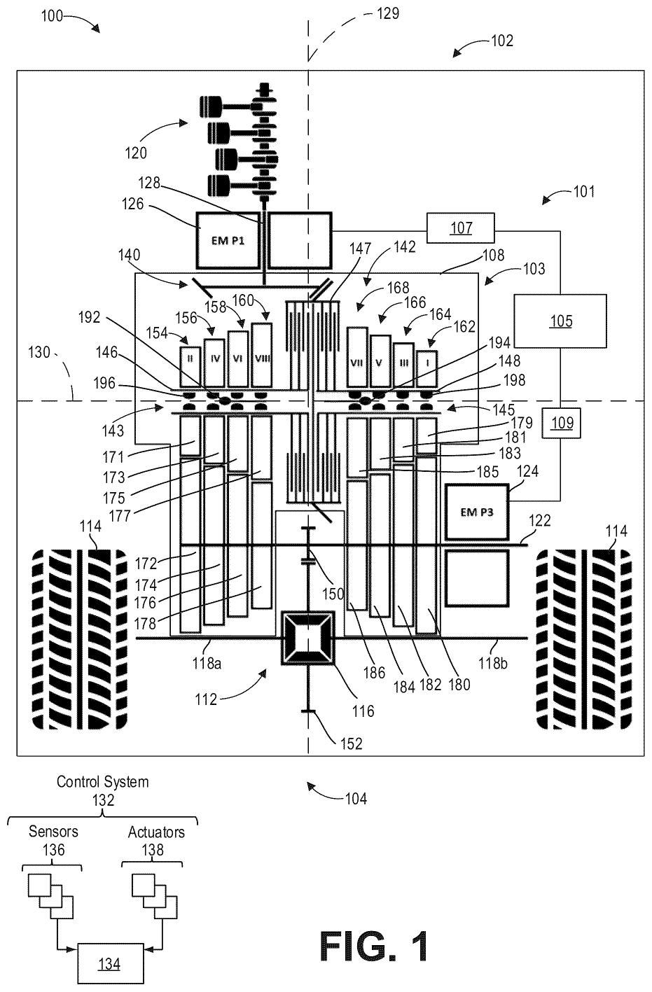

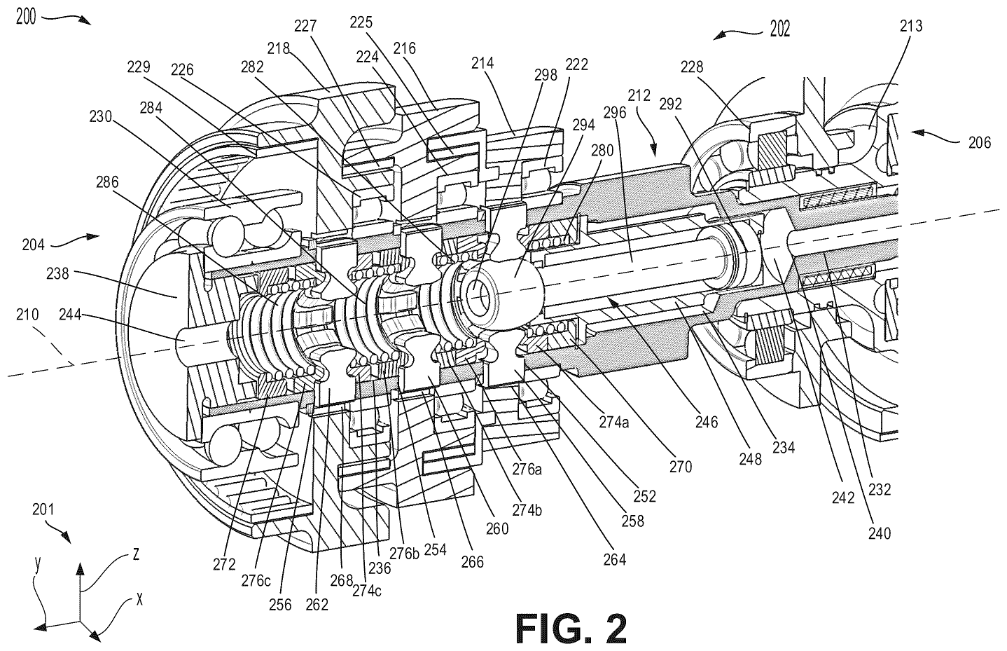

FIG. 1 shows an example schematic of a vehicle including a transmission and a gear selection assembly of the present disclosure. The transmission may be a dual clutch hybrid transmission with a first electric machine and a second electric machine. FIG. 2 shows a sectional view of a dog clutch assembly comprising a hollow shaft with a rod. The dog clutch assembly includes a plurality of pass-through holes extending from an inner surface to an outer surface of the shaft arranged radially around a central axis of the shaft. Each of the plurality of pass-through holes may house a sliding key, where the sliding keys may extend radially outward from the shaft through the pass-through holes. The pass-through holes may be slots. The pass through holes and their respective sliding keys may be arranged into sets, where each set is arranged radially around a separate point along the central axis. A gear may be arranged radially around each set of pass-through holes and sliding keys, where the gear is selectable (e.g., be a selected gear) such that the sliding keys selectively couple to the shaft. The sliding keys of a set may extend and slide in a radially outward direction into a plurality of recesses of a specific gear, engaging with the recesses to selectively couple the specific gear to the shaft. When selectively coupled, the sliding keys of the set may rigidly couple the gear to the shaft. Additionally, when the gear is selectively coupled, all sets of keys and all sliding sleeves of the dog clutch assembly realize an interlock, whereby realizing the interlock the other sliding sleeves of the dog clutch assembly reduce the distance other sets of keys may be translated radially outward compared to the set of keys selectively coupled to the gear. The rod includes a cam-shaped section that may contact the set of sliding keys, translating the set of sliding keys radially outward. The dog clutch assembly includes a plurality of sleeves, where each set of the sliding keys are sandwiched between a pair of the sleeves.

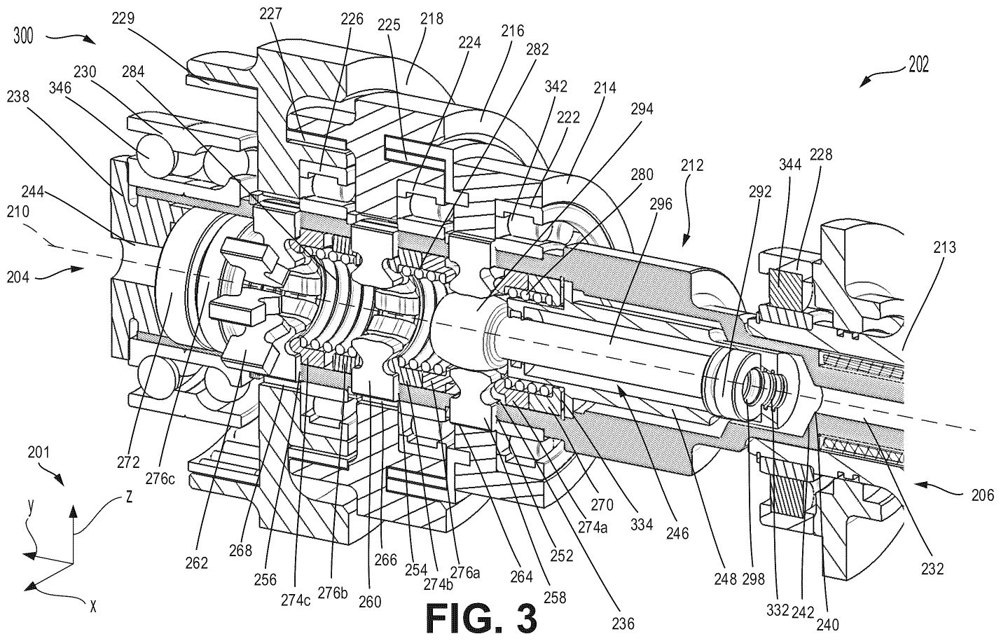

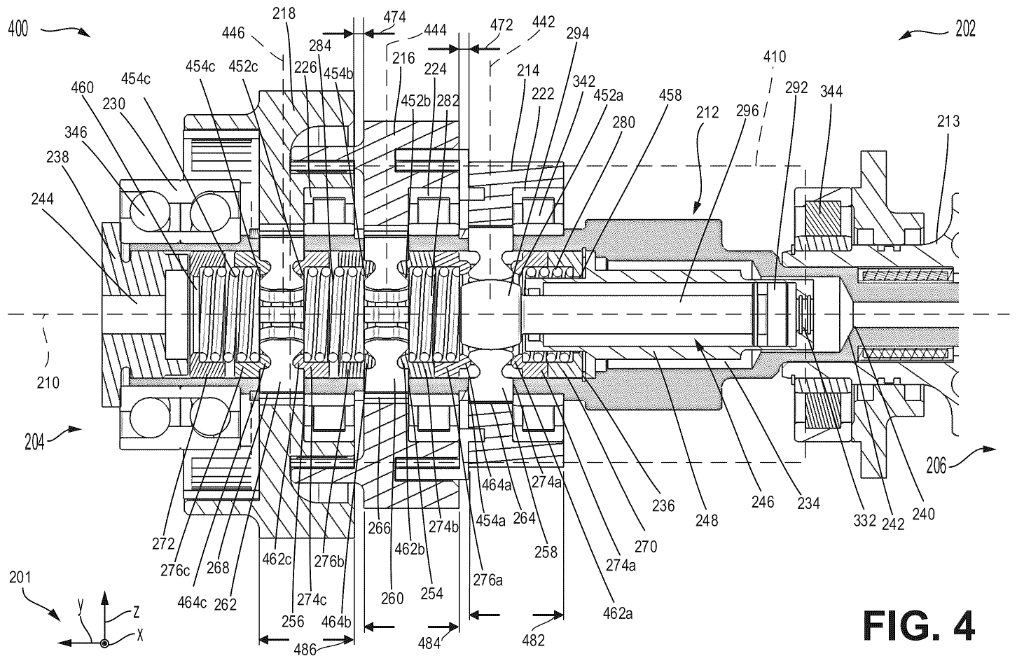

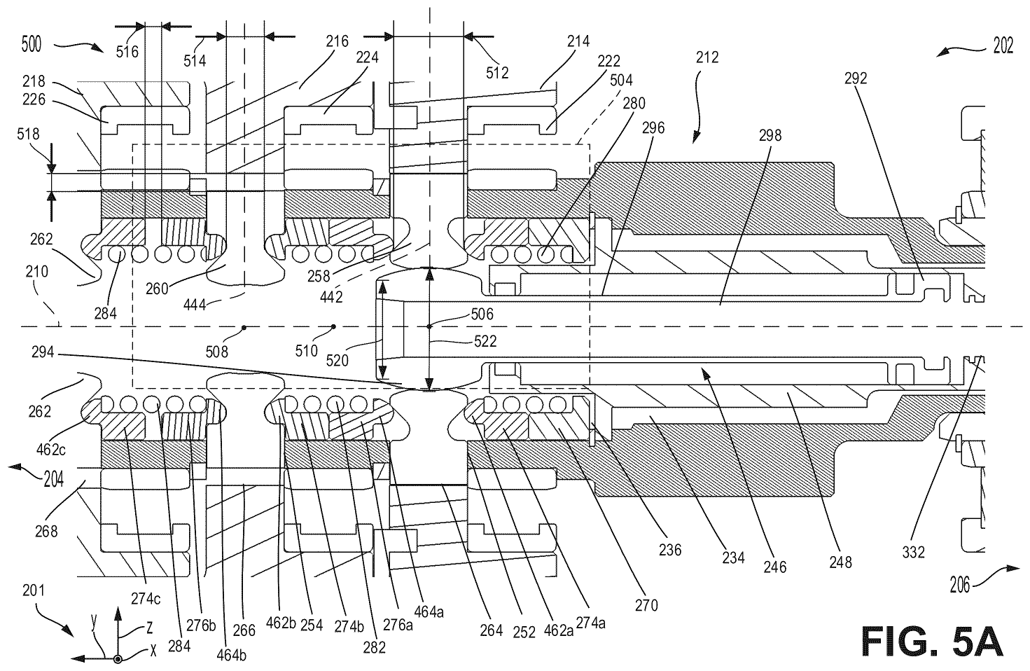

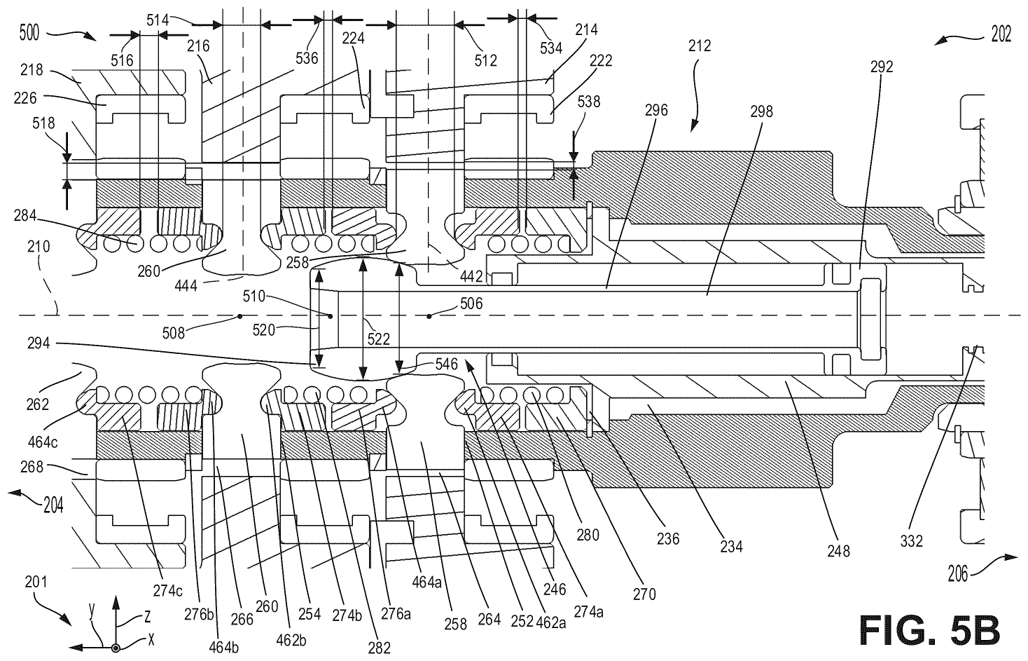

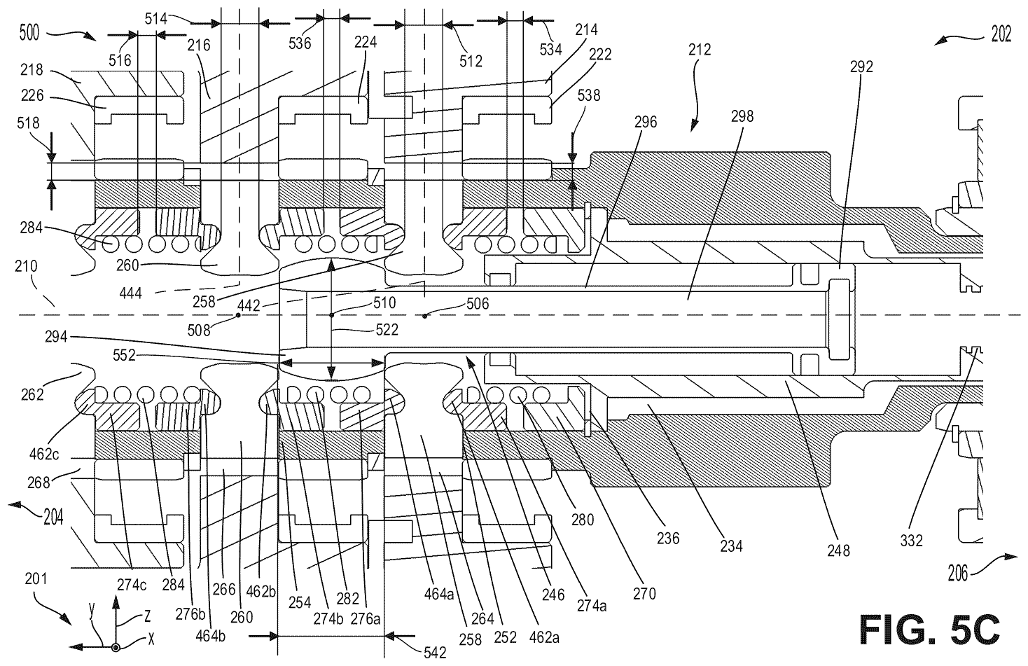

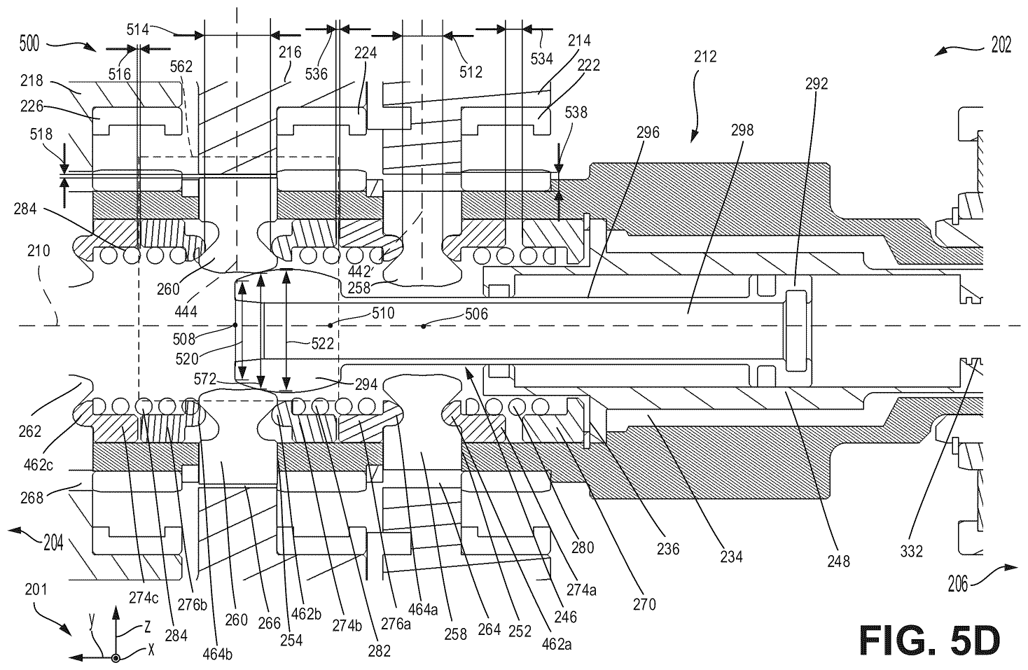

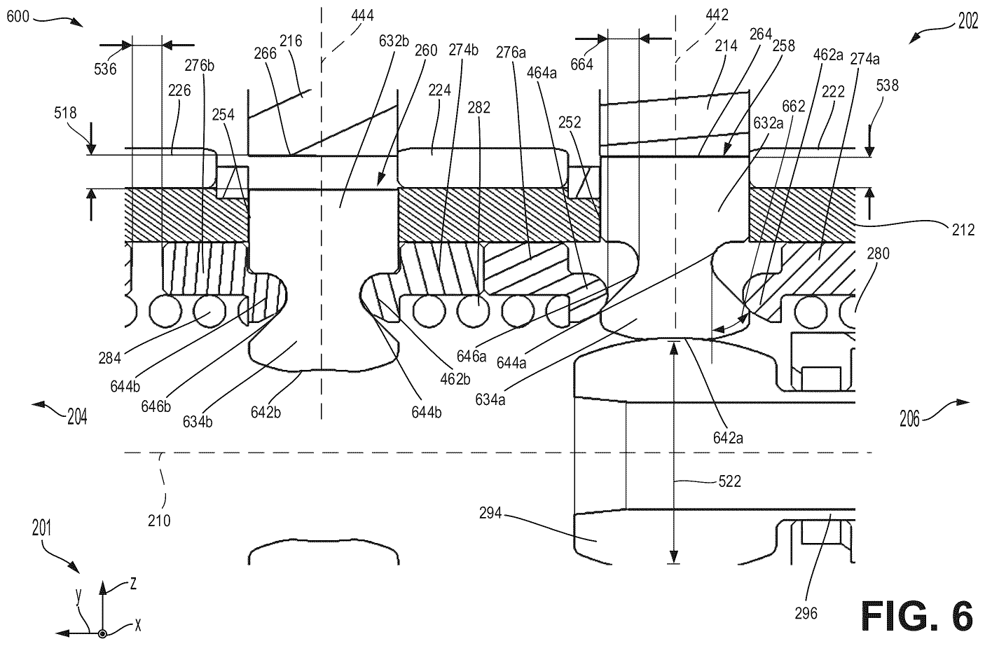

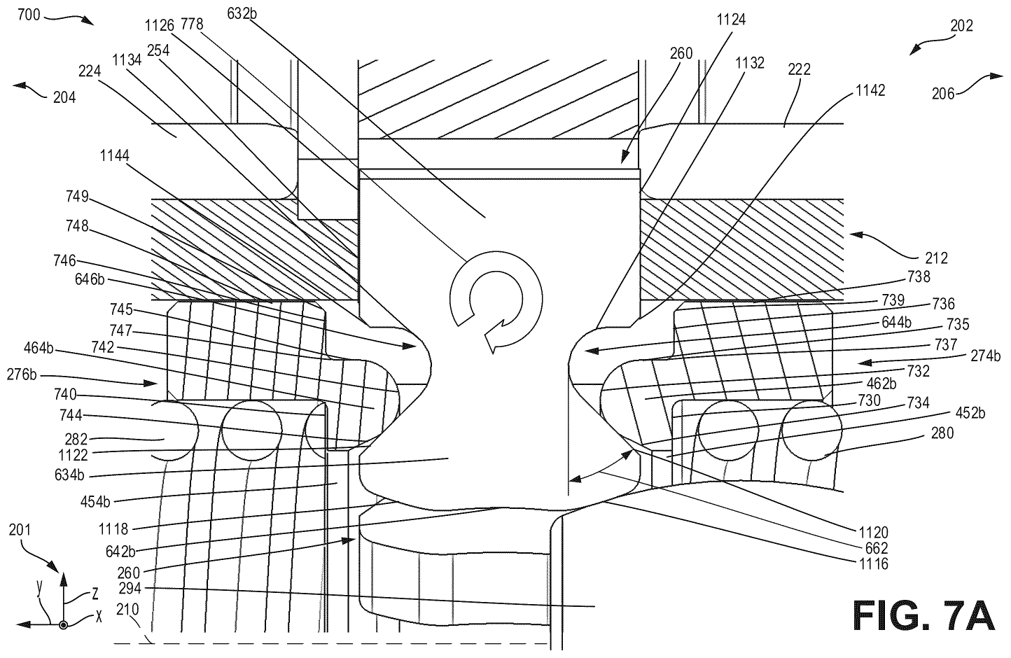

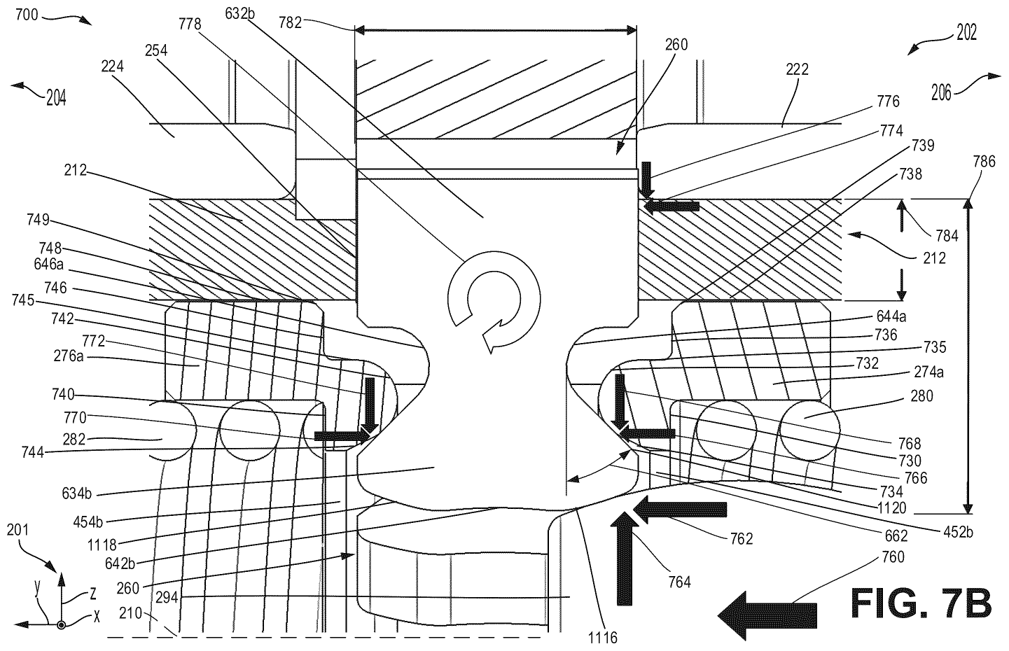

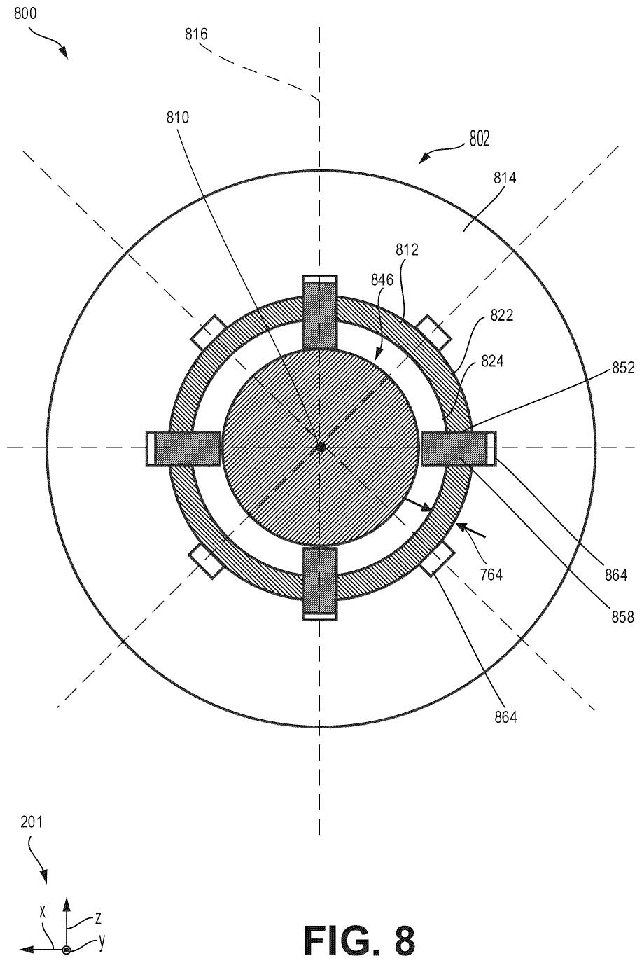

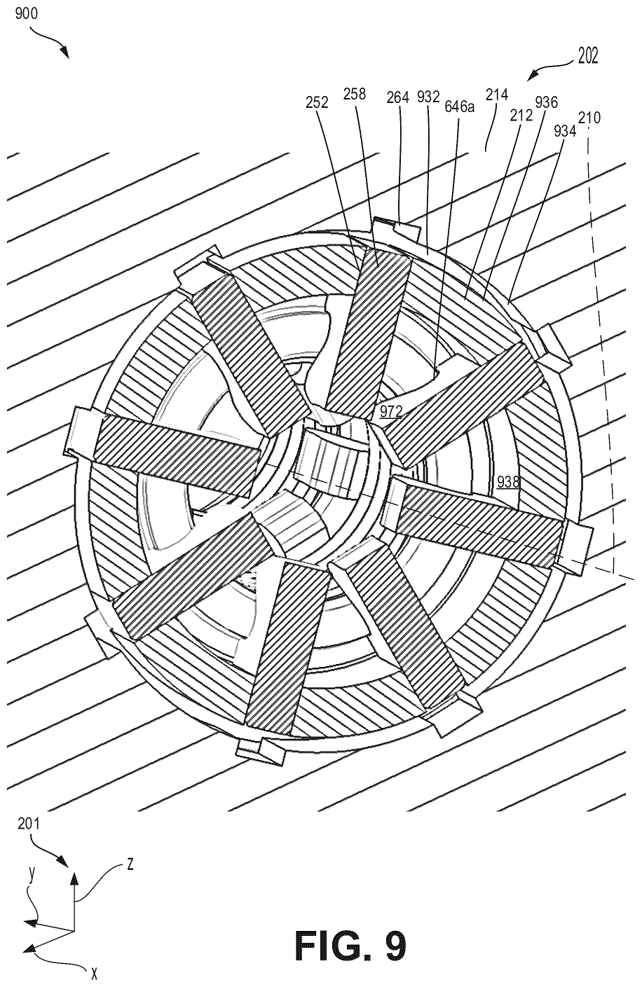

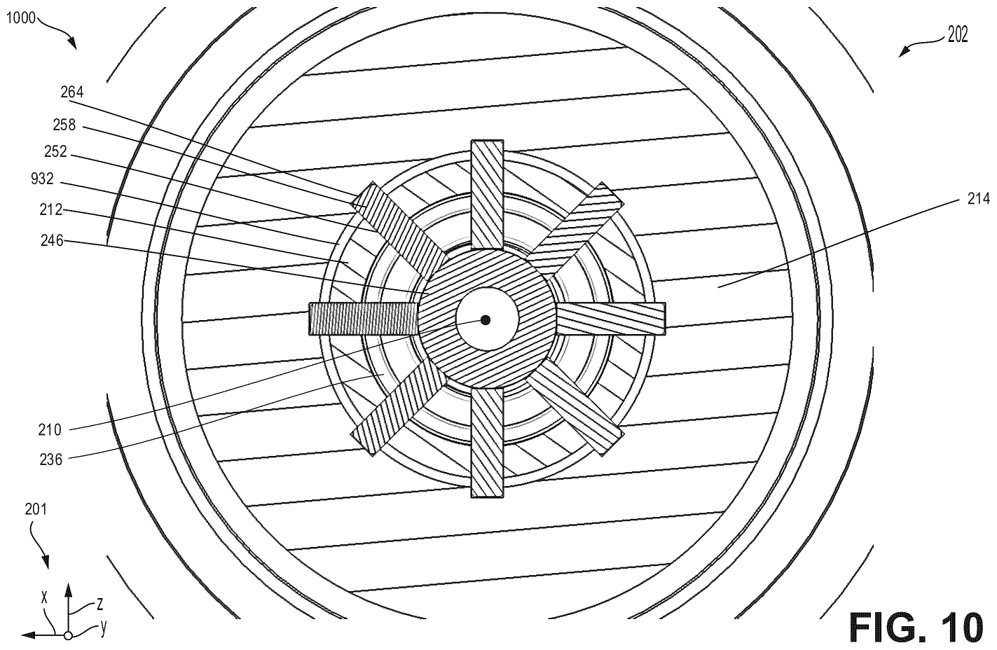

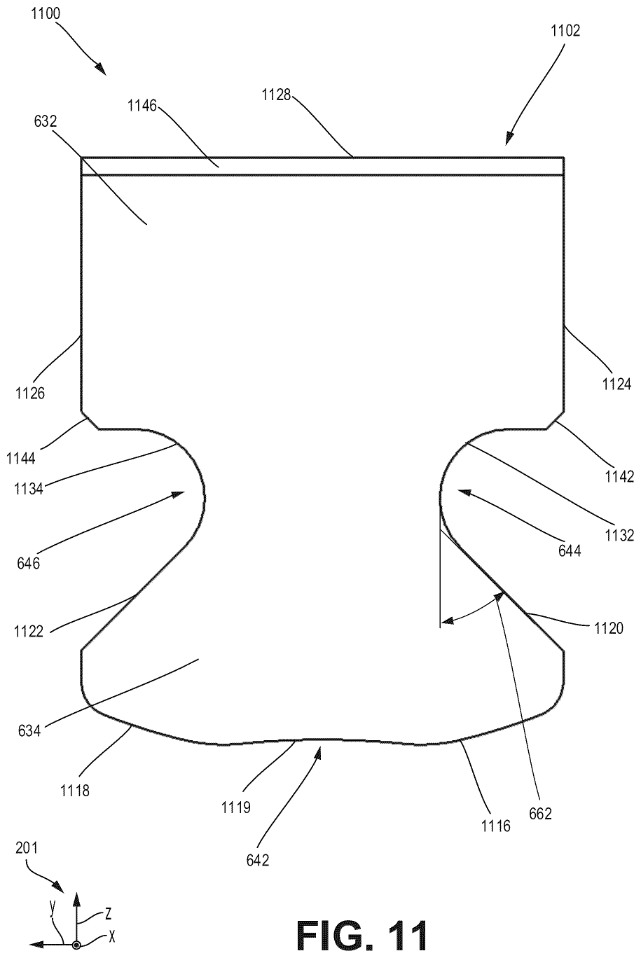

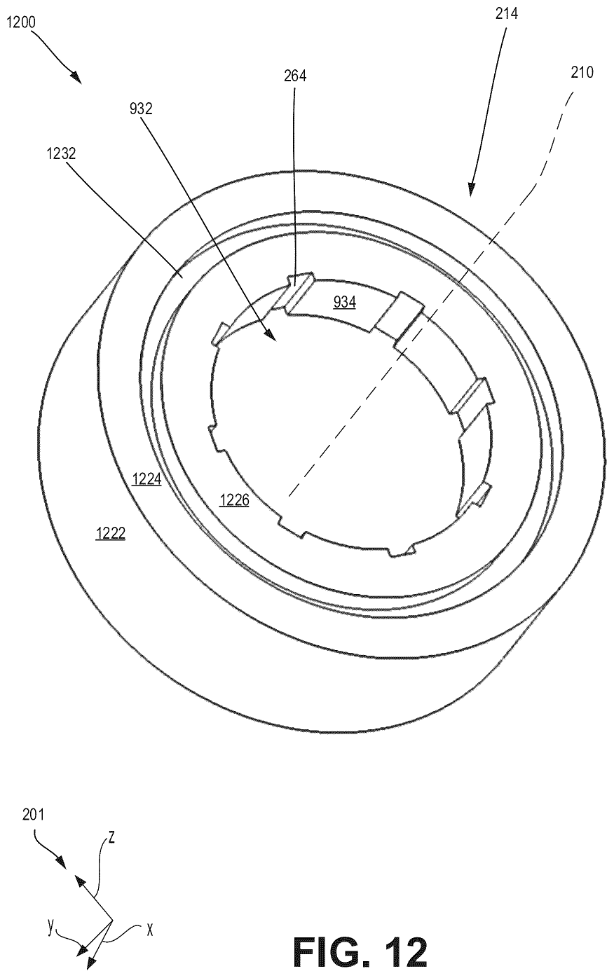

FIG. 3 shows a side and sectional view of the dog clutch assembly. FIG. 4 shows a side and sectional view of the dog clutch assembly. FIG. 5A shows a side and sectional view of the rod of the dog clutch assembly in a first position, where the cam-shaped section abuts a plurality of first sliding keys. In the first position, cam-shaped section contacts the sliding keys at a portion of the cam-shaped section where the diameter is at a maximum. FIG. 5B shows the side and sectional view of the rod of the dog clutch in a second position. In the second position, cam-shaped section contacts the sliding keys at another portion of the cam-shaped section where the diameter is smaller than the maximum. FIG. 5C shows the side and sectional view of the rod of the dog clutch in a third position. In the third position the cam-shaped section is a neutral position axially between the first sliding keys and a plurality of second keys. FIG. 5D shows the side and sectional view of the rod of the dog clutch in a fourth position. In the fourth position the cam-shaped section contacts the second keys. FIG. 6 shows a side and sectional view of the rod of the dog clutch in the first position. FIG. 6 shows additional feature of the sliding keys and the sleeves. FIG. 7A shows a side and sectional view of the rod of the dog clutch in the fourth position. FIG. 7B shows the side and sectional view of the dog clutch in the fourth positon with a plurality of forces. FIG. 8 shows a schematic of a dog clutch, a rod, and a gear of the present disclosure. FIG. 9 shows a perspective and sectional view of the dog clutch, a gear, and a set of keys. FIG. 10 shows a front and sectional view of the dog clutch, the gear, the keys, and a rod. FIG. 11 shows a sectional view a sliding key of the present disclosure. FIG. 12 shows a side and perspective view of a gear of the present disclosure. FIG. 12 shows a perspective view of the recesses and their pattern around the gear.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 and FIG. 8 shows schematics of an example configurations with relative positioning of the various components. FIGS. 2-7B and FIGS. 9-12 show example configurations with approximate position. FIGS. 2-7B and FIGS. 9-12 are shown approximately to scale; though other relative dimensions may be used. As used herein, the terms “approximately” is construed to mean plus or minus five percent of the range unless otherwise specified.

Further, FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

Features described as drivingly coupled are coupled such as to drive one another. Said in another way, a first component drivingly coupled to a second component may drive the second component and vice versa. Said in another way, rotational power may be transferred from a first component to a second component when the first component drivingly couples the second component. A component described as a driving component may drive another component. A component described as a driven component may be driven by another component.

Turning to FIG. 1, a vehicle 100 is shown comprising a powertrain 101 and a drivetrain 103. The vehicle 100 may have a front end 102 and a rear end 104, located on opposite sides of vehicle 100. Objects, components, and features of the vehicle 100 referred to as being located near the front may be closest to the front end 102 compared to the rear end 104. Objects, components, and features of the vehicle 100 referred to as being located near the rear may be closest to the rear end 104 compared to the front end 102. The vehicle 100 may have a longitudinal axis 129. The powertrain 101 and drivetrain 103 may have a length parallel with the longitudinal axis 129. The vehicle 100 may have a lateral axis 130.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be a plane, a boat, or other vehicle system. Additionally or alternatively, the vehicle 100 and/or one or more of its components, such as components of the powertrain 101 and/or the drivetrain 103, may be used in industrial, locomotive, military, agricultural, and/or aerospace applications. In an example, the vehicle 100 is an all-electric vehicle or a vehicle with all-electric modes of operation, such as a plug-in hybrid vehicle.

The powertrain 101 may be electrified, and therein the drivetrain 103 and driveline may be electrified. The drivetrain 103 and driveline may therein be an electrified drivetrain and an electrified driveline, respectively. The powertrain 101 may comprise a first electric machine 124, a second electric machine 126, and a transmission 108. The first electric machine 124 and the second electric machine 126 are movers such as electric motors or electric motor/generators. The first electric machine 124 may be in a first position (P1) and the second electric machine 126 may be in a second position (P3). The first position may be closer to the front end 102 and the second position may be closer to the rear end 104. The electric machines 124, 126 may provide rotary power to the transmission via inputs. For example, the first electric machine 124 may drivingly couple to a first driveshaft 122, such as to drive the first driveshaft 122. The first electric machine 124 may drivingly couple and provide rotary power to the transmission via the first driveshaft 122. The second electric machine 126 may drivingly couple to a second drive shaft 128, such as to drive the second drive shaft 128. The second electric machine 126 may drivingly couple and provide rotary power to the transmission via the second drive shaft 128.

The powertrain 101 may also include an engine 120. The engine 120 may be an internal combustion engine (ICE) or a non-electric motor mover. The engine 120 may provide rotary power to the transmission 108. For example, the engine 120 may drivingly couple to a second drive shaft 128, such as to drive the second drive shaft 128. The engine 120 may drivingly couple and provide rotary power to the transmission via the second drive shaft 128.

The vehicle 100 and power train may include a prime mover. For an example, the prime mover may be an internal combustion engine (ICE) such as the engine 120. For another example, the prime mover may be an electric machine, such as the first electric machine 124 or the second electric machine 126. The prime mover is operated to provide rotary power to the transmission 108. The transmission 108 receives the rotary power produced by the prime mover as an input and outputs rotary power to the drivetrain 103 in accordance with a selected gear or setting.

The prime mover may be powered via energy from an energy storage device 105. For example, the energy storage device 105 is a battery, such as a traction battery, configured to store electrical energy. For another example, the energy storage device 105 may be another device configured to store electrical energy, such as capacitor. An inverter 107 may be arranged between the energy storage device 105 and the first electric machine 124 and configured to adjust direct current (DC) to alternating current (AC). Likewise, an inverter 109 may be arranged between the energy storage device 105 and the second electric machine 126 and configured to adjust DC to AC. The inverters 107, 109 may include a variety of components and circuitry with thermal demands that effect an efficiency of the inverters.

The drivetrain 103 is shown in a rear-wheel drive configuration, although other configurations are possible. For one or more examples, the drivetrain 103 may include a front-wheel drive, a four-wheel drive configuration, or an all-wheel drive configuration. As such, the drivetrain 103 may have other configurations without departing from the scope of this disclosure, and the configuration shown in FIG. 1 is provided for illustration, not limitation.

The drivetrain 103 may include an axle assembly 112. The axle assembly 112 may be or include an axle configured to drive a set of wheels 114. The axle of the axle assembly 112 is a drive axle. In one example, the axle assembly 112 is arranged near the rear of the vehicle 100 and thereby comprises a rear axle. For another example, the axle assembly 112 may be arranged near the front of the vehicle 100 and thereby comprise a front axle. Further, the drivetrain 103 may include one or more tandem axle assemblies. For other examples, there may be one or more axle assemblies in addition to axle assembly 112. For example, there may be an additional axle assembly arranged near the front of the vehicle 100 separate from the axle assembly 112. The additional axle assembly may be drivingly coupled to a transmission such as to be driven. For example, the additional axle may be drivingly coupled to the transmission 108 or another transmission. The vehicle 100 may include additional wheels and axles that are not coupled to the drivetrain 103. As such, the drivetrain 103 may have other configurations without departing from the scope of this disclosure, and the configuration shown in FIG. 1 is provided for illustration, not limitation.

The vehicle 100 may have a first driveshaft 122. The transmission 108 may be drivingly coupled the axle assembly 112 via the first driveshaft 122. Said in another way, the transmission 108 may drivingly couple to the first driveshaft 122, and the first driveshaft 122 may drivingly couple the axle assembly 112. In some configurations, such as shown in FIG. 1, the drivetrain 103 includes a transfer case configured to receive rotary power output by the transmission 108. The first driveshaft 122 may drivingly couple to the transfer case and may be drivingly coupled to the transmission 108 via the transfer case.

The transmission 108 may be a gearbox. Alternatively, the transmission 108 may be an axle transmission or a transaxle transmission, and may be arranged or be part of an axle assembly such as the axle assembly 112. In some embodiments, additionally or alternatively, the transmission 108 may be a first transmission, and the vehicle 100 may have one or more other transmissions, such as a second transmission. The second transmission may be arranged nearer to the rear side or in another position of the vehicle 100 compared to transmission 108.

The axle assembly 112 may include a differential 116 and a first set of axle shafts. The differential 116 may drivingly couple the first set of axle shafts such as to transfer torque to and drive the first set of axle shafts. The first set of axle shafts may include a first shaft 118a and a second shaft 118b. The first shaft 118a and the second shaft 118b may be axle half shafts. The differential 116 may distribute unequal torque to wheel drivingly coupled at opposite ends of the axle assembly 112. For example, the differential 116 may distribute unequal torque to the first shaft 118a and the second shaft 118b.

The transmission 108 may drivingly couple to and output rotary power to the axle assembly 112 via the differential 116. Additionally, the first driveshaft 122 may be an input to and drivingly couple to the output rotary power to the axle assembly 112 via the differential 116. The first driveshaft 122 may rigidly couple or comprise a pinion gear 150. The pinion gear 150 may mesh and drivingly couple to the differential gearset of the differential 116. The differential gearset of differential 116 includes a ring gear 152. The pinion gear 150 may mesh with the ring gear 152, and therein drive the ring gear 152. The ring gear 152 may drive the differential gears and other gears of the differential 116, therein driving the first shaft 118a and the second shaft 118b.

For an example, transmission 108 may be a transversal dual clutch hybrid transmission including one or more of a plurality of clutch assemblies of the present disclosure. The gear selection assembly 142 may comprise a first dog clutch assembly 143 and/or a second dog clutch assembly 145. The first dog clutch assembly 143 and the second dog clutch assembly 145 may selectively couple to the outer drum 147 of a disconnect assembly. The disconnect assembly comprising the outer drum 147 may be a clutch, such as a friction clutch. The outer drum 147 may house and selectively couple to one or more clutches, such as friction clutches. The clutches housed by the outer drum 147 may be wet clutches. The transmission 108 may include a pinion gear 140. A bevel gearset comprises the pinion gear 140.

The first dog clutch assembly 143 may selectively couple to the engine 120 and/or the second electric machine 126, via the outer drum 147 of a disconnect assembly. When selectively coupled via outer drum 147, the first dog clutch assembly 143 may drivingly couple to the engine 120 and/or the second electric machine 126. Said in another way, the first dog clutch assembly 143 may be driven and receive rotational energy, such as torque, from the engine 120 and second electric machine 126. Further, the second dog clutch assembly 145 may selectively couple to the engine 120 and the second electric machine 126, via the outer drum 147. When selectively coupled via the outer drum 147, the second dog clutch assembly 145 may drivingly couple to the engine 120 and/or the second electric machine 126. Said in another way, the second dog clutch assembly 145 may be driven and receive rotational energy from the engine 120 and second electric machine 126.

The clutches of the outer drum 147 may include a first clutch and a second clutch, where a first clutch may selectively couple the first dog clutch assembly 143 to the drum 147, and the second clutch may selectively couple the second dog clutch assembly 145 to the drum 147. Said in another way, the clutches may include an odd clutch and an even clutch, where the odd clutch may selectively couple to an odd dog clutch assembly to the drum 147, and the even clutch may selectively couple the even dog clutch assembly to the drum 147. The odd dog clutch assembly may be the second dog clutch assembly 145, where odd numbered gear speeds of the transmission 108 may be selected thereby. The even dog clutch assembly may be the first dog clutch assembly 143, where even numbered gear speeds of the transmission 108 may be selected thereby.

The drum 147 may selectively couple to the first dog clutch assembly 143 or the second dog clutch assembly 145 via a plurality of plates. For an example, a first set of plates may rigidly couple to the drum 147, a second set of plates may rigidly couple to the first dog clutch assembly 143, and a third set of plates may rigidly couple to the second dog clutch assembly 145. The drum 147 may selectively couple the first dog clutch assembly 143 via contact between the first set of plates and the second set of plates. The first clutch of the drum 147 that selectively couples the first dog clutch assembly 143 may comprise the first set of plates and the second set of plates. Likewise, the drum 147 may selectively couple the second dog clutch assembly 145 via contact between the first set of plates and the third set of plates The second clutch of the drum 147 that selectively couples the second dog clutch assembly 145 may comprise the first set of plates and the third set of plates. The first dog clutch assembly 143 may comprise a third shaft 146. The second plates may rigidly couple to the third shaft 146. The second dog clutch assembly 145 may comprise a fourth shaft 148. The third plates may rigidly couple to the fourth shaft 148. The third shaft 146 may be referred to as an even shaft, such as if the first dog clutch assembly 143 is an even dog clutch assembly. Likewise, the fourth shaft 148 may be referred to as an odd shaft, such as if the second dog clutch assembly 145 is an odd dog clutch assembly.

The pinion gear 140 may drivingly couple the engine 120 and the second electric machine 126 to the outer drum 147, such that rotational energy may be transferred therein to the outer drum 147. The second drive shaft 128 may drivingly couple to the pinion gear 140, such as to transmit rotary power and drive the pinion gear 140. The pinion gear 140 may be drivingly coupled to the gear selection assembly 142, such as to transmit rotary power and drive the components of the gear selection assembly 142. More specifically the pinion gear 140 may drivingly couple to the gear selection assembly via drivingly coupling the drum 147. For an example, the pinion gear 140 may drive the first dog clutch assembly 143, when the first dog clutch assembly 143 is selectively coupled to outer drum 147. For another example, the pinion gear may drive the second dog clutch assembly 145, when the second dog clutch assembly 145 is selectively coupled to the outer drum 147.

The third shaft 146 and the fourth shaft 148 may have lengths parallel with the lateral axis 130. The third shaft 146 and the fourth shaft 148 may be positioned radially around the lateral axis 130. The first dog clutch assembly 143 and the second dog clutch assembly 145 are dog clutch assemblies of the present disclosure each including an interlocking radial face dog clutch. The interlocking radial face dog clutch has mechanical integrated interlocking capabilities allowing for the first dog clutch assembly 143 and the second dog clutch assembly 145 to interlock and selectively couple to specific gears of gearsets.

Adjustment of the drivetrain 103 between the various modes of operation as well as control of operations within each mode may be executed based on a vehicle control system 132, including a controller 134. Controller 134 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 134 may be a powertrain control module (PCM).

Controller 134 may receive various signals from sensors 136 coupled to various regions of vehicle 100. For example, the sensors 136 may include sensors at the prime mover or another mover of the vehicle 100 to measure mover speed and mover temperature, a pedal position sensor to detect a depression of an operator-actuated pedal, such as an accelerator pedal or a brake pedal, a lever position sensor to detect a shifting of a lever, such as a brake lever, speed sensors at the set of wheels 114 etc. For this example, the sensors 136 may include sensors at detect engagement of a gear shift selector that may select gearsets of different ratios of the transmission 108, such as for if the transmission 108 is an automatic transmission. The clutch selection device may be a lever or another clutch shifter. Upon receiving the signals from the various sensors 136 of FIG. 1, controller 134 processes the received signals, and employs various actuators 138 of vehicle 100 to adjust drivetrain operations based on the received signals and instructions stored on the memory of controller 134. For example, controller 134 may receive an indication of depression of the brake pedal, signaling a desire for decreased vehicle speed. Vehicle braking may be directly proportional to accelerator pedal position, for example, degree of depression. For another example, controller 134 may receive an indication of depression of the accelerator pedal, signaling a desire for increased vehicle speed. Vehicle acceleration may be directly proportional to accelerator pedal position, for example, degree of depression. In response, the controller 134 may command operations, such as shifting gear and gear modes of the transmission 108. Alternatively, the gear modes of the transmission 108 may be shifted manually, such as if the transmission 108 is a manual transmission.

Returning to the transmission 108, a plurality of first gearsets, such as at least two gearsets (e.g., a gearset and another gearset), may drivingly couple to the third shaft 146, such as to be driven by or drive the third shaft 146. Likewise, a plurality of second gearsets, such as at least two gearsets, may drivingly couple to the fourth shaft 148, such as to be driven by or drive the fourth shaft 148. The first dog clutch assembly 143 and the second dog clutch assembly 145 are configured to have an interlock capability preventing more than one gear from selectively coupling either the third shaft 146 or the fourth shaft 148. Each of the first gearsets has at least a gear that may selectively couple the third shaft 146 and another gear that that rigidly couples the second shaft, such that one of the plurality of gearsets may selectively couple the third shaft 146 and drivingly couple the third shaft 146 to the second drive shaft 128. When realized, the interlock capability of the first dog clutch assembly 143 ensures that the third shaft 146 may only selectively couple to one gear of the first gearsets at a time. Likewise, each of the second gearsets may have at least a gear that selectively couples the fourth shaft 148 and another gear that rigidly couples the second drive shaft 128, such that the two gearsets may therein be selectively coupled to the fourth shaft 148 and drivingly couple the fourth shaft 148 to the second drive shaft 128. When realized, capability of the second dog clutch assembly 145 ensures the fourth shaft 148 may only selectively couple to a gear of the second gearsets at a time. A gearset that is selected to drivingly couple the third shaft 146 or the fourth shaft 148 to the second shaft may be referred to herein as a selected gearset. A gear selectively coupled to the third shaft 146 or fourth shaft 148 may be referred to herein as a selected gear.

The gear selection assembly may include shafts that are hollow, where each hollow shaft houses a rod and a plurality of keys. The rod may be translated through a hollow shaft to press upon a set of keys of the plurality of keys. When contacted and pressed upon by the rod, the key of the plurality of keys may rotationally couple the hollow shaft to a specific gearset, where the key selectively coupling the shaft to a gear of the gearset. For example, the third shaft 146 may house a first rod 192 and a plurality of first keys 196. The first rod 192 may be translated coaxially along the lateral axis 130 or another axis the third shaft 146 is centered about. A set of keys of the first keys 196 may be pressed upon by the first rod 192 to selectively couple the third shaft 146 to a gear of a selected gearset of the first gearsets. Likewise, the fourth shaft 148 may house a second rod 194 and a plurality of second keys 198. The second rod 194 may be translated coaxially along the lateral axis 130 or another axis the fourth shaft 148 is centered about. A set of keys of the second keys 198 may be pressed upon by the second rod 194 to selectively couple the fourth shaft 148 to a gear of a selected gearset of the second gearsets.

For an example, the first gearsets may include a first gearset 154, a second gearset 156, a third gearset 158, and a fourth gearset 160 that are of different ratios. The third shaft 146 may rotatably couple and drivingly couple to the first driveshaft 122 via the first gearset 154, the second gearset 156, the third gearset 158, or the fourth gearset 160 via selectively coupling a gear of each gearset. Each of the first gearsets includes at least a first gear and a second gear. For example, the first gearset 154 includes a first gear 171 and a second gear 172. The second gearset 156 includes a third gear 173 and a fourth gear 174. The third gearset 158 includes a fifth gear 175 and a sixth gear 176. The fourth gearset 160 includes a seventh gear 177 and an eighth gear 178.

The first rod 192 may be translated to press upon a set of keys of the first keys 196 to selectively couple the third shaft 146 to the first gear 171, the third gear 173, the fifth gear 175, or the seventh gear 177. Only a gear of the first gear 171, the third gear 173, the fifth gear 175, or the seventh gear 177 may be selectively coupled to the third shaft 146 at a time via the first rod 192. The first driveshaft 122 may rigidly couple to the second gear 172, the fourth gear 174, the sixth gear 176, and the eighth gear 178. The first gear 171 may mesh with the second gear 172. The third gear 173 may mesh with the fourth gear 174. The fifth gear 175 may mesh with the sixth gear 176. The seventh gear 177 may mesh with the eighth gear 178. Alternatively, there may be one or more idler gears intermeshed between the first gear 171 and the second gear 172, the third gear 173 and the fourth gear 174, the fifth gear 175 and the sixth gear 176, and/or the seventh gear 177 and the eighth gear 178.

Additionally or alternatively, the second gearsets may include a fifth gearset 162, a sixth gearset 164, a seventh gearset 166, and an eighth gearset 168 that are of different ratios. The fourth shaft 148 may rotatably couple and drivingly couple to the first driveshaft 122 via the fifth gearset 162, the sixth gearset 164, the seventh gearset 166, or the eighth gearset 168 via selectively coupling a gear of each gearset. Each of the second gearsets includes at least a third gear and a fourth gear. The fifth gearset 162 includes a ninth gear 179 and a tenth gear 180. The sixth gearset 164 includes an eleventh gear 181 and a twelfth gear 182. The seventh gearset 166 includes a thirteenth gear 183 and a fourteenth gear 184. The eighth gearset 168 includes a fifteenth gear 185 and a sixteenth gear 186.

The second rod 194 may be translated to press upon a set of keys of the second keys 198 to selectively couple the fourth shaft 148 to the ninth gear 179, the eleventh gear 181, the thirteenth gear 183, or the fifteenth gear 185. Only a gear of the ninth gear 179, the eleventh gear 181, the thirteenth gear 183, or the fifteenth gear 185 may be selectively coupled to the fourth shaft 148 at a time via the second rod 194. The first driveshaft 122 may rigidly couple to the tenth gear 180, the twelfth gear 182, the fourteenth gear 184, and the sixteenth gear 186. The ninth gear 179 may mesh with the tenth gear 180. The eleventh gear 181 may mesh with the twelfth gear 182. The thirteenth gear 183 may mesh with the fourteenth gear 184. The fifteenth gear 185 may mesh with the sixteenth gear 186. Alternatively, there may be one or more idler gears intermeshed between the ninth gear 179 and the tenth gear 180, the eleventh gear 181 and the twelfth gear 182, the thirteenth gear 183 and the fourteenth gear 184, and/or fifteenth gear 185 and the sixteenth gear 186.

Each gearset that may be selected by the first dog clutch assembly and the second dog clutch assembly may correspond to a different gear speed of the transmission. Odd gear speeds (e.g., odd numbered gear speeds) and even gear speeds (e.g., even numbered gear speeds) may be selected by different dog clutch assemblies of the transmission 108. For example, the first dog clutch assembly 143 is an even dog clutch assembly that may select even gear speeds for the transmission 108. Likewise, the second dog clutch assembly 145 is an odd dog clutch assembly that may select odd gear speeds of the transmission 108. The gear speeds may be greater in ratio with greater numerical numbers assigned thereto. Gears to select a gearset of gear speed, may be labeled with a roman numeral reflecting the number of the gear speed in FIG. 1.

For this example, the ninth gear 179 is labeled with a roman numeral I for one, and when the ninth gear 179 is engaged via the second dog clutch assembly 145, a first gear speed may be selected for the transmission 108. Said in another way, selecting the fifth gearset 162 selects the first gear speed for the transmission 108. The eleventh gear 181 is labeled with a roman numeral III for three, and when the eleventh gear 181 is engaged via the second dog clutch assembly 145, a third gear speed may be selected for the transmission 108. Said in another way, selecting the sixth gearset 164 selects the third gear speed for the transmission 108. The thirteenth gear 183 is labeled with a roman numeral V for five, and when the thirteenth gear 183 is engaged via the second dog clutch assembly 145, a fifth gear speed may be selected for the transmission 108. Said in another way, selecting the seventh gearset 166 selects the fifth gear speed for the transmission 108. The fifteenth gear 185 is labeled with a roman numeral VII for seven, and when the fifteenth gear 185 is engaged via the second dog clutch assembly 145, a seventh gear speed may be selected for the transmission 108. Said in another way, selecting the eighth gearset 168 selects the seventh gear speed for the transmission 108.

Additionally or alternatively, the first gear 171 is labeled with a roman numeral II for two, and when the first gear 171 is engaged via the first dog clutch assembly 143, a second gear speed may be selected for the transmission 108. Said in another way, selecting the first gearset 154 selects the second gear speed for the transmission 108. The third gear 173 is labeled with a roman numeral IV for four, and when the third gear 173 is engaged via the first dog clutch assembly 143, a fourth gear speed may be selected for the transmission 108. Said in another way, selecting the second gearset 156 selects the fourth gear speed for the transmission 108. The fifth gear 175 is labeled with a roman numeral VI for six, and when the fifth gear 175 is engaged via the first dog clutch assembly 143, a sixth gear speed may be selected for the transmission 108. Said in another way, selecting the third gearset 158 selects the sixth gear speed for the transmission 108. The seventh gear 177 is labeled with a roman numeral VIII for eight, and when the seventh gear 177 is engaged via the first dog clutch assembly 143, an eighth gear speed may be selected for the transmission 108. Said in another way, selecting the fourth gearset 160 selects the eighth gear speed for the transmission 108.

It is to be appreciated that the number of gear speeds selectable by the transmission 108 may be non-limiting, where greater than or fewer than eight gear speeds may be selectable by the transmission 108. For example, the transmission 108 may be a six speed transmission with six selectable gear speeds. For another example, the transmission 108 may be a four speed transmission with four selectable gear speeds.

It is also to be appreciated, that the number of gear speeds selectable by the first dog clutch assembly 143 may be non-limiting, with a greater or fewer amounts of gear speeds being selectable by the first dog clutch assembly 143 than four gear speeds. Likewise, it is to be appreciated that the number of gear speeds selectable by the second dog clutch assembly 145 may be non-limiting, with a greater or fewer amount of speeds being selectable by the second dog clutch assembly 145 than four gear speeds. For example, there may be at least two gear speeds selectable by the first dog clutch assembly 143 and/or at least two gear speeds selectable by the second dog clutch assembly 145.

In this way the transmission of a driveline assembly is shown, where the transmission comprises one or more dog clutch assemblies. Each dog clutch assembly comprises a hollow shaft comprising at least two sets of radial pass-through holes including a first set and a second set of radial pass-through holes; a plurality of gears arranges around the shaft. Each dog clutch assembly comprises a plurality of sliding keys configured to extend through the pass-through holes of the shaft and engage in the recesses of a selected gear. When engaged, the selected gear is selectively coupled to the shaft, such as to rotate and spin with the shaft. Each dog clutch assembly comprises a plurality of sliding sleeves, where each sliding key is interposed between two sliding sleeves that are spring-compressed to abut the key in such a way that only one gear may be selected. Each dog clutch assembly comprises a rod configured to translate coaxially to and along the shaft, where the rod comprises a cam-shaped section configured to actuate the plurality of sliding keys of the selected gear.

A set of reference axes 201 are provided for comparison between views shown in FIGS. 2-3. The reference axes 201 indicate a y-axis, an x-axis, and a z-axis. In one example, the z-axis may be parallel with a direction of gravity, and the x-y plane may be parallel with a horizontal plane that a dog clutch assembly 202 of FIG. 2 may rest upon. A circle may represent an axis of the reference axes 201 that is normal to a view. A circle may represent an axis of the reference axes 201 that is normal to a view. A filled circle may represent an arrow and axis facing toward, or positive to, a view. An unfilled circle may represent an arrow and an axis facing away, or negative to, a view.

Turning to FIG. 2, a first view 200 of the dog clutch assembly 202 is shown. The first view 200 is a sectional view of the dog clutch assembly 202. The dog clutch assembly 202 has a first side 204 and a second side 206, where the first side 204 is opposite the second side 206. The dog clutch assembly 202 may be the axle assembly 112 of FIG. 1.

The dog clutch assembly 202 is centered on an axis 210. The axis 210 may therein be a central axis. Additionally, the axis 210 may be a rotational axis that rotational elements of the dog clutch assembly 202 may spin or rotate radially about. The axis 210 may be a longitudinal axis for the dog clutch assembly 202, and directions parallel with the axis 210 may be referred to as longitudinal herein. However, it is to be appreciated that relative to a vehicle, such as the vehicle 100 of FIG. 1, the axis 210 may be a lateral axis 130 of FIG. 1.

The dog clutch assembly 202 includes a first a shaft 212, a body 213, and a plurality of toothed gears. The body 213 may be arranged radially around the shaft 212, and the shaft 212 may rotate independently from the body 213. The toothed gears may be selectively coupled to the shaft 212, where each gear may be supported by at least a bearing assembly allowing the toothed gears to rotate freely of the shaft 212. The gears may be idler gears.

For an example, the dog clutch assembly 202 may include a first gear 214, a second gear 216, and a third gear 218 may be arranged radially around the shaft 212. A first bearing assembly 222 may be sandwiched radially between the first gear 214 and the shaft 212, where the first bearing assembly 222 has surface sharing contact with the first gear 214 and the shaft 212. The second bearing assembly 224 may be sandwiched radially between the second gear 216 and the shaft 212, where the second bearing assembly 224 has surface sharing contact with the second gear 216 and the shaft 212. The third bearing assembly 226 may be sandwiched radially between the third gear 218 and the shaft 212, where the third bearing assembly 226 has surface sharing contact with the third gear 218 and the shaft 212. The first bearing assembly 222, the second bearing assembly 224, and the third bearing assembly 226 may be roller bearings, each comprising a plurality of roller bearing elements between an inner and outer race. It is to be appreciated that the first gear 214, the second gear 216, and the third gear 218 may be supported by additional bearings.

A fourth bearing assembly 228 may be arranged radially around and in surface sharing contact with the body 213. The body 213 is a disc supporting one or more clutch drums for the bearing assembly, such as the drum 147 of FIG. 1. The fourth bearing assembly 228 may therein support a clutch assembly and one or more clutch drums therein that may selectively couple to the dog clutch assembly 202. The fourth bearing assembly 228 may be closer to the second side 206 from the first bearing assembly 222. A fifth bearing assembly 230 may be arranged radially around and in surface sharing contact with the shaft 212. The fifth bearing assembly 230 may be closer to the first side 204 from the third bearing assembly 226. The fifth bearing assembly 230 may include one or more bearings. For example, the fifth bearing assembly 230 may include a double row angular contact ball bearing. The fifth bearing assembly 230 may be coupled to the shaft 212 via a locking nut 238. The locking nut 238 may prevent translation or other movement of the fifth bearing assembly 230, such as in directions parallel with the axis 210.

Some of the additional bearings are interposed axially between adjacent gears or a gear an another component to support and allow rotation therein. For example, each of the first gear 214, the second gear 216, and the third gear 218 may be supported by a pair of bearings. A first pair of bearing assemblies supporting the first gear 214 may include the first bearing assembly 222 and a sixth bearing assembly 225. The sixth bearing assembly 225 may be interposed between the first gear 214 and the second gear 216. More specifically, the sixth bearing assembly 225 may be sandwiched radially between the first gear 214 and the second gear 216. A second pair of bearing assemblies supporting the second gear 216 may include the second bearing assembly 224 and a seventh bearing assembly 227. The seventh bearing assembly 227 may be interposed between the second gear 216 and the third gear 218. More specifically, the seventh bearing assembly 227 may be sandwiched radially between the second gear 216 and the third gear 218. A third pair of bearing assemblies supporting the third gear 218 may include the third bearing assembly 226 and an eighth bearing assembly 229. The eighth bearing assembly 229 may be interposed between the third gear 218 and the fifth bearing assembly 230. Likewise, another component may be interposed between the third bearing assembly 226 and the fifth bearing assembly 230. The sixth bearing assembly 225, the seventh bearing assembly 227, and the eighth bearing assembly 229 may be or include a bearing, such as a roller bearing. For example, the sixth bearing assembly 225, the seventh bearing assembly 227, and the eighth bearing assembly 229 may be or include a needle roller bearing, comprising a plurality of needle roller elements.

The first gear 214, the second gear 216, and the third gear 218 may be idler gears. The first gear 214 may be a gear such as the seventh gear 177 or the fifteenth gear 185 of FIG. 1. The second gear 216 may be a gear such as the fifth gear 175 or the thirteenth gear 183 of FIG. 1. The third gear 218 may be a gear such as the third gear 173 or the eleventh gear 181 of FIG. 1.

The shaft 212 may include a first fluid passage 232 and a second fluid passage centered radially around the axis 210. The second fluid passage includes a first section 234 and a second section 236 of different diameters. The second diameter of the second section 236 may be greater than first diameter of the first section 234. The first section 234 may be fluidly coupled to the first fluid passage 232 via an opening 240. The first section 234 may comprise a countersink 242 extending radially from the opening 240.

The locking nut 238 may rigidly couple to shaft 212 via the second section 236. The locking nut 238 may be a plug. The locking nut 238 may comprise a flange that may extend radially and abut the fifth bearing assembly 230. The locking nut 238 may have an opening 244 that may fluidly couple to the second section 236. Fluid may exit the shaft 212 and the second section 236 via the opening 244. The opening 244 may be concentric to the locking nut 238, and the locking nut 238 and the opening 244 may be centered radially around the axis 210. The opening 244 may deliver lubricant and/or actuation fluid to another clutch, such as another dog clutch. For example, if the dog clutch assembly 202 is an even clutch, the opening 244 may deliver lubricant to an odd clutch, and vice versa. The opening 244 may also receive lubricant and/or actuation fluid. Fluid may be delivered to and pressure may be increased to the second fluid passage via the opening 244.

The shaft 212 may embody a hydraulic cylinder. The first section 234 may house a rod 246 and a frame 248 that may be centered radially around the axis 210. The frame 248 may be the body (e.g., a pressure body) of the hydraulic cylinder and may be positioned radially around the rod 246. The frame 248 may center the rod 246 approximately centered around the axis 210, and may reduce the rod 246 from moving in a direction perpendicular to or at an angle greater than +/−5% from the axis 210. The frame 248 may be fixed such as to rigidly couple to the shaft 212. The rod 246 may be translated directions parallel with, such as coaxial with, the axis 210. When translated past one or more thresholds of distance, the rod 246 may abut the frame 248 reducing further translation of the rod 246 in a direction. For example, the rod 246 may be reduced from moving past a first point or a second point along the axis 210 by abutting the frame 248, where surfaces at opposite ends of the frame 248 abut and reduce movement of the rod 246. The hydraulic cylinder may actuate the rod 246 via changes in hydraulic pressure. During actuation, the rod 246 may be translated to different positions along the axis 210.

It is to be appreciated, that the rod 246 may additionally or alternatively be actuated via electrical means, such as via pure electric actuation or electro-hydraulic actuation. The rod 246 may therein be actuated via an electric machine, such as an electric motor.

Turning briefly to FIG. 8, it shows a seventh view 800 of a dog clutch assembly 802 that includes a shaft 812, a gear 814, and a cam 846 centered radially around an axis 810. The dog clutch assembly 802 is shown schematically with relative positioning and dimensions. The axis 810 may be the axis 210 of FIG. 2. The dog clutch assembly 802 may be the dog clutch assembly 202 of FIG. 2. Likewise, the shaft 812 and cam 846 may be the shaft 212 and a cam 294 of FIG. 2. The rod 246 of FIG. 2 may comprise or rigidly couple to the cam 294. Further, the gear 814 may be the first gear 214, the second gear 216, or the third gear 218 of FIG. 2. A plurality of axes 816 may extend radially outward and be perpendicular to the axis 810.

The shaft 812 comprises a plurality pass-through holes 852 extending from an outer surface 822 to an inner surface 824 through the shaft 812. The gear 814 may comprise a plurality of recesses 864. The pass-through holes 852 are arranged radially around and extend radially outward through the shaft 812, the pass-through holes 852 may therein be referred to alternatively as a radial pass-through holes 852. The pass-through holes 852 may be slots. The shaft 812 may also house a plurality of keys 858 via the pass-through holes 852, where each pass-through hole of the pass-through holes 852 may house at least a key of the keys 858. The pass-through holes 852 may be slots that are rectangular in shape and sectional area, and the pass-through holes 852 may be prismatic in volume.

The pass-through holes 852 are dimensions, such that the keys 858 may be translated radially outward and inward through the pass-through holes 852 via sliding, and may be referred to alternatively herein as sliding keys 858. When each sliding key of the sliding keys 858 is translated, the sliding key slides radially outward or inward from the axis 810. The sliding keys 858 may be compelled to translate and extend radially outward from the shaft 812 via contact with the cam 846. When translated and extended in such a manner, sliding keys such as sliding keys 858 may be referred to as extracted from the shaft 812. The sliding keys 858 may be compelled to translate and retract radially inward to the shaft 812 via removal of contact from the cam 846. When each sliding key of the sliding keys 858 retract, the sliding key may slide inward toward the axis 810 along an axis of the axes 816. When translated radially inward in such a manner, sliding keys 858 may be referred to as retracted.

The gear 814 may include a plurality of recesses 864 extending in a radially outward direction from an inner surface of the gear 814. The recesses 864 may be slots that are rectangular in shape and sectional area, and the recesses 864 may be prismatic in volume. The number of recesses 864 may be multiple of the number of pass-through holes 852, increasing the speed of engagement and enabling the shaft 812 to be more robust during engagement. The greater the number of recesses 864 relative the number of pass-through holes 852 may increase speed of engagement.

The pass-through holes 852 may be grouped and arranged into a set corresponding with the gear 814, where the gear 814 is positioned radially around the pass-through holes 852, such that each pass-through hole of the pass-through holes 852 may align with at least a recess of the recesses 864, where each pass-through hole of the pass-through holes 852 is centered around a common axis with a recess of the recesses 864. For example, each of the pass-through holes 852 may be centered with a recess of the recesses 864 around an axis of the axes 816. Likewise, the sliding keys 858 may be grouped into another set corresponding with the set of pass-through holes 852 and the gear 814, where the sliding keys 858 may be extracted from the shaft 812 and engaged with recesses 864. To engage with the recesses 864, each of the sliding keys 858 may slide along an axis of the axes 816. When engaged with the recesses 864, the sliding keys 858 may selectively couple the gear to the shaft 812.

For each gear of the dog clutch assembly 802 there is a corresponding set of pass-through holes and sliding keys, where the corresponding set of sliding keys extend to engage with recesses of the gear selectively coupling the gear to the shaft 812. The dog clutch assembly 802 may include at least a first set and a second set of pass-through-holes and a first set and a second set of sliding keys. The where the first sets of the pass-through holes and sliding keys correspond to and selectively couple a first gear. The second set of pass-through holes and sliding keys correspond to and selective couple a second gear.

There, may be a minimum of three sliding keys for each set of sliding keys, and therein a minimum of three pass-through holes for each set of pass-through holes. The three sliding keys are to guarantee the system balancing for the dog clutch assembly 802, as only one key of a set of keys can unbalance the system due to the centrifugal force. Fewer than three sliding keys may not guarantee the correct positioning of the rod to contact the sliding keys of a set, as the rod may be maintained centered along the axis 810 and held in position by the sliding keys, sliding keys 858. However, it is to be appreciated that there may be more than three sliding keys for each set of sliding keys and three pass-through holes for each set of pass-through holes. For example, there may be four of the sliding keys 858 and four of the pass-through holes 852.

Returning to FIG. 2, the shaft 212 may include a plurality pass-through holes, where a key may be fit to and extend through each pass-through hole. The radial pass-through holes may be arranged radially around the axis 210 and extend radially outward through the material of the shaft 212. The radial pass-through holes may be organized into a plurality of sets. Each radial set of pass-through holes may be arranged in a ring like pattern around the axis 210. Each set of pass-through holes may have a complementary set of keys, where each key of the set of keys are fit to and may be translated through a radial pass-through hole of the set of radial pass-through holes. Each set of pass-through holes is specific to a gear, wherein the gear is positioned radially around the set of radial pass-through holes. The shaft 212 may include at least two sets of radial pass-through holes with a set of keys. However, it is to be appreciated, that the shaft 212 may include more than two sets of radial pass-through holes, where there may be a set of radial pass-through holes added to the shaft 212 during manufacturing for each gear desired to be selected via the dog clutch.

The set of keys complementary to the set of radial pass-through holes may be translated radially outward and abut features of the gear. Features of the gear that may be abutted via the set of keys include recesses, where each key may be extracted via translation into a volume of the recess. Each key may abut and make contact against surfaces of the recess and lock with recess when extracted. The radial pass-through holes have geometries reducing self-locking of a respective set of sliding keys. For example, the radial pass through-holes are larger in cross sectional area and widths than the keys allowing for the keys to be slid in, however the cross-sectional areas and the widths are below a first threshold of area and a second threshold of distance reducing instances of keys, and may prevent keys, from sliding without deliberate force above a third threshold of force. Likewise, a pair of sleeves on opposite sides of each set of keys and the geometries of the sleeves may reduce self-locking of the keys, by reducing radial movement of the keys without a force greater than a fourth threshold of force. Above the fourth threshold of force, the sleeves may be spread apart, allowing for a set of keys to be translated radially outward through the radial pass-through holes.

The second fluid passage, and more specifically the second section 236, may houses a plurality of springs and a plurality of springs. The second fluid passage may also house plurality of hard stops, such as a first hard stop 270 and a second hard stop 272. Each key of the keys may be axially along the axis 210 between a pair of the sleeves and a pair of the springs. One or more springs of the springs may be axially along the axis 210 between a pair of springs. Additionally, one or more of other springs of the springs may be axially along the axis 210 between a hard stop of the hard stops and a sleeve of the sleeves. There may be at least one more spring than the total number of key sets. For example, if there are three sets of keys, there may be four springs.

Each set of set of keys may be sandwiched axially between a set of sleeves. Each set of sleeves includes at least a pair of sleeves. Said in another way, each set of sliding sleeves comprises a first sliding sleeve and a second sliding sleeve that may be positioned on opposite sides of a set of keys. The sleeves may be translated and spread apart along the axis 210. The sleeves may be translated via sliding and therein be referred to alternatively herein as sliding sleeves. A sleeve and another sleeve of the pair of sleeves may abut each key of the set of keys on opposite sides in axial directions with respect to axis 210. The sleeve and the another sleeve may be supported by the shaft. A spring may be sandwiched between the sleeve and a surface. Likewise, another spring may be sandwiched between the other sleeve and another surface. The spring and the other spring provide spring forces to opposite sides of the keys via contact with the sleeve and the other sleeve, respectively. Said in another way, the spring may press the sleeve and the other spring may press the other sleeve against the set of keys therebetween. The spring force of the spring and the other spring may compel the set of keys to retract into the shaft 212. Each set of sliding sleeves may reduce radial translation of one or more keys of a sets of keys sandwiched between the sliding sleeves when there is no contact between the rod 246 and the keys. Each of the sliding sleeves of the dog clutch assembly 202 is part of a set of sliding sleeves specific to a set of keys sandwiched therebetween.

For example, the shaft 212 may have a first set of first pass-through holes 252, a second set of second pass-through holes 254, and a third set of third pass-through holes 256. A set of a plurality of first keys 258 may be fit to and be housed by the first pass-through holes 252. A set of a plurality of second keys 260 may be fit to and housed by the second pass-through holes 254. A plurality of third keys 262 may be fit to and be housed by the third pass-through holes 256. The first keys 258, the second keys 260, and the third keys 262 may be translated radially outward from the axis 210 through the first pass-through holes 252, the second pass-through holes 254, and the third pass-through holes 256, respectively. The first keys 258, the second keys 260, and the third keys 262 may be translated via sliding and therein may be referred to as sliding keys (e.g., the first sliding keys 258, the second sliding keys 260, and the third sliding keys 262). The first pass-through holes 252, second pass-through holes 254, and the third pass-through holes 256 may be cut from the shaft 212 via a machining technique, such as via milling.

The first gear 214 may have a plurality of first recesses 264, where the first recesses 264 extend radially outward into the material of the first gear 214. The second gear 216 may have a plurality of second recesses 266, where the second recesses 266 extend radially outward into the material of the second gear 216. The third gear 218 may have a plurality of third recesses 268, where the third recesses 268 extend radially outward into the material of the third gear 218. The recesses 264, 266, 268 may depress radially outward from an inner diameter of the first gear 214, the second gear 216, and the third gear 218, respectively. The recesses 264, 266, 268 may be cut from the first gear 214, the second gear 216, and the third gear 218 respectively via a machining technique, such as via broaching. The first gear 214 may be arranged around the shaft 212, such that the first recesses 264 are positioned radially around the first pass-through holes 252. The second gear 216 may be arranged around the shaft 212, such that the second recesses 266 are positioned radially around the second pass-through holes 254. The third gear 218 may be arranged around the shaft 212, such that the third recesses 268 are positioned radially around the third pass-through holes 256.

The first keys 258, the second keys 260, the third keys 262 may be symmetric. Likewise, the number of recesses of the first recesses 264, the second recesses 266, and the third recesses 268, may be symmetric. Further the number the first recesses 264, the second recesses 266, and/or the third recesses 268 may be multiple of the number of the first keys 258, the second keys 260, the third keys 262, respectively.

The first keys 258 may be sandwiched axially with respect to the axis 210 between a first sleeve 274a and a second sleeve 276a. The first sleeve 274a and the second sleeve 276a are a first set of sliding sleeves. The second keys 260 may be sandwiched axially with respect to the axis 210 between a third sleeve 274b and a fourth sleeve 276b. The third sleeve 274b and the fourth sleeve 276b are a second set of sliding sleeves. The third keys 262 may be sandwiched axially with respect to the axis 210 between a fifth sleeve 274c and a sixth sleeve 276c. The fifth sleeve 274c and the sixth sleeve 276c are a third set of sliding sleeves. The first hard stop 270 may be nearer to the second side 206 of the assembly from the second hard stop 272, and the first hard stop 270 may abut the frame 248. The second hard stop 272 may abut the locking nut 238. A first spring 280 may be sandwiched axially between and contacted by the first hard stop 270 and the first sleeve 274a. A second spring 282 may be sandwiched axially between and contacted by the second sleeve 276a and the third sleeve 274b. A third spring 284 may be sandwiched axially between and contacted by the fourth sleeve 276b and the fifth sleeve 274c. A fourth spring 286 may be sandwiched axially between and contacted by the sixth sleeve 276c and the second hard stop 272. The first sleeve 274a, the third sleeve 274b, the fifth sleeve 274c may be symmetric. Likewise, the second sleeve 276a, the fourth sleeve 276b, the sixth sleeve 276c may be symmetric. The first sleeve 274a may be symmetric with and mirror the second sleeve 276a. The third sleeve 274b may be symmetric with and mirror the fourth sleeve 276b. The fifth sleeve 274c may be symmetric with and mirror the sixth sleeve 276c.

The rod 246 comprises a cam-shaped section 294, a piston section, and a stem 296. The stem 296 connects and physically couples the piston section at a first end to the cam-shaped section 294 at a second end of the rod 246, where the first end of the rod 246 is opposite the second end. The piston section comprises or is a piston referred to herein as a piston 292. The piston 292 may have a larger diameter compared to a maximum diameter of the cam-shaped section 294. Likewise, the cam-shaped section 294 comprises or is a cam. The piston 292 includes a land with a cylindrical shape extending radially outward from the stem 296. The cam-shaped section 294 may be elliptical in shape, such as an oval shaped cam. The cam-shaped section 294 may press on one or more keys of a set of keys to be translated and spread radially such as the first keys 258, the second keys 260, or the third keys 262. The frame 248 may fluidly seal against the stem 296.

The first keys 258, the second keys 260, or the third keys 262 may be translated radially outward or radially inward from the axis 210 through the first pass-through holes 252, the second pass-through holes 254, or the third pass-through holes 256. Contact with the rod 246 may compel the first keys 258, the second keys 260, or the third keys 262 to be translated radially outward and extracted from the shaft 212. More specifically, contact with the cam-shaped section 294 may compel the first keys 258, the second keys 260, or the third keys 262 to be translated radially outward and be extracted from the shaft 212. When extracted, the first keys 258 may engage with the first recesses 264, such as to abut and rigidly couple with the first recesses 264, selectively coupling the first gear 214 to the shaft 212. When extracted, the second keys 260 may engage with the second recesses 266, such as to abut and rigidly couple with the second recesses 266, selectively coupling the second gear 216 to the shaft 212. When extracted, the third keys 262 may engage with the third recesses 268, such as to abut and rigidly couple with the third recesses 268, selectively coupling the third gear 218 to the shaft 212.

Lack of contact with the cam-shaped section 294 may compel the first keys 258, the second keys 260, or the third keys 262 to be translated radially inward and be retracted toward the shaft 212. Contact from the first sleeve 274a and the second sleeve 276a, and spring force from the first spring 280 and the second spring 282, may compel the first keys 258 to be retracted toward the shaft 212. Contact from the third sleeve 274b and the fourth sleeve 276b, and spring force from the second spring 282 and the third spring 284, may compel the second keys 260 to be retracted toward the shaft 212. Contact from the fifth sleeve 274c and the sixth sleeve 276c, and spring forces from the third spring 284 and the fourth spring 286, may compel the third keys 262 to be retracted toward the shaft 212.

It is to be appreciated that keys, such as the first keys 258, the second keys 260, and the third keys 262 may be reduced from retracting during transfer of torque to and rotation of the shaft 212. If transmission of torque to and rotation of the shaft 212 persists, then a set of sliding keys selectively coupling a gear to the shaft 212 may remain coupled to their respective gear recesses, even after the cam-shaped section 294 has been removed from an engaged position with the keys. This, in turn, keeps an adjacent set of keys mechanically locked, reducing the cam-shaped section 294 from compelling adjacent keys to the locked keys moving radially outward upon contact and reducing the rod 246 from engaging the next gear or any other gear. In such cases, a locked sleeve that the locked keys are sandwiched between obstructs the movement of the rod 246 along the axis 210. The locked keys may be contacted by the rod 246 and reduced from moving by the locked sleeve, and therein the locked keys may reduce further axial movement of the rod 246 when pressing against the locked keys. The relationship between an extracted set of keys preventing the extraction of other sets of keys via the sliding sleeves may be referred to an interlock feature of the dog clutch assembly 202.

Said in another way, the first keys 258, the second keys 260, and the third keys 262, may realize an interlock with the first sleeve 274a and second sleeve 276a, the third sleeve 274b and fourth sleeve 276b, and the fifth sleeve 274c and sixth sleeve 276c, respectively. The interlock may allow either the first keys 258, the second keys 260, or the third keys 262 extend and extract, while the distance other keys extend may be reduced below a threshold of distance. Additionally or alternatively, the interlock may prevent the other sets of keys of dog clutch assembly 202 from extracting besides keys from sets of keys that are extracted or being extracted. The threshold of distance is less than a radial distance for keys of the other sets of keys of the dog clutch assembly 202 to extend and be extracted into their respective recesses. For example, when translated in a radial direction less than the threshold of distance the first keys 258, the second keys 260, or the third keys 262 are un-extended from into the first recesses 264, the second recesses 266, and the third recesses 268, respectively. Said in another way, the first keys 258, the second keys 260, or the third keys 262 remain un-extracted when translated in a radial direction less than the threshold of distance.

The hydraulic cylinder may actuate the cam of the cam-shaped section 294 by changing hydraulic pressure to an actuation chamber between the piston 292 and the opening 240. The actuation chamber may be enclosed by the frame 248 and formed between the piston 292 and a surface of the frame 248.

The hydraulic cylinder may be a double sided hydraulic cylinder, where pressure may be increased on either side of the piston 292 translating the rod 246 in directions opposite the side of the pressure increase therein. For an example, increase in hydraulic pressure to the chamber at the side of the piston 292 facing the second side 206, may compel the rod 246 to translate toward the first side 204. Likewise, increasing the hydraulic pressure to the chamber at the side of the piston 292 facing the first side 204, may compel the rod 246 to translate toward the second side 206. The hydraulic pressure cylinder may therein translate the cam-shaped section 294 into and out of contact with either the first keys 258, second keys 260, or third keys 262.

Turning to FIG. 3, it shows a second view 300 of the dog clutch assembly 202. The second view 300 is a side and sectional view of the dog clutch assembly 202.

The second view 300 shows the frame 248 includes an opening 332. The opening 332 may be centered radially about the axis 210 and may be concentric to the frame 248. The opening 332 may place the third fluid passage 298 in fluid communication with the first fluid passage 232.

A fastener 334 may rigidly couple the frame 248 to the shaft 212. The fastener 334 may be a snap ring having a tongue and groove arrangement with an inner surface of the shaft 212. More specifically, the fastener 334 may have a tongue and groove arrangement with a surface of the shaft 212 curving radially about the second section 236.

The first bearing assembly 222, the second bearing assembly 224, and the third bearing assembly 226 may each include a plurality of first bearing elements 342. The fourth bearing assembly 228 may include a plurality of second bearing elements 344. And the fifth bearing assembly 230 may include a plurality of third bearing elements 346. The first and second bearing elements 342, 344 may be roller bearing elements. The third bearing elements 346 may be ball bearing elements.

Turning to FIG. 4, it shows a third view 400 of the of the dog clutch assembly 202. The third view 400 is a side and sectional view of the dog clutch assembly 202. The third view 400 includes an area 410. The area 410 is surrounded by a rectangle of dashed lines. Another sectional view, such as the fourth view 500 of FIGS. 5A-5D may be taken from area 410.

The dog clutch assembly 202 includes a plurality of key axes via which each key of the sets of keys 258, 260, 262 may slide axially along. Each set of key axes may be the axes 816 of FIG. 8. For example, each key of the first keys 258 may slide radially outward from or inward toward the axis 210 along a first key axis of a plurality of first key axes 442. Each key of the second keys 260 may slide radially outward from or inward toward the axis 210 along a second key axis of a plurality of second key axes 444. Each key of the third keys 262 may slide radially outward from or inward toward the axis 210 along a third key axes 446 of a plurality of third key axes 446. The first key axes 442, the second key axes 444, and the third key axes 446 extend in a radial direction from the axis 210. The centerlines of the first keys 258, the second keys 260, and the third keys 262 may be coaxial with the first key axes 442, the second key axes 444, and the third key axes 446. Likewise, each of the first pass-through holes 252 and the first recesses 264 may be centered around a first axis of the first key axes 442. Each of the second pass-through holes 254 and the second recesses 266 may be centered around a second axis of the second key axes 444. Each of the third pass-through holes 256 and the third recesses 268 may be centered around a third axis of the third key axes 446. The first keys 258 may translate via sliding through the first pass-through holes 252 and into the first recesses 264 along the first key axes 442. The second keys 260 may translate via sliding through the second pass-through holes 254 and into the second recesses 266 along the second key axes 444. The third keys 262 may translate via sliding through the third pass-through holes 256 and into the third recesses 268 along the third key axes 446. In the example of the dog clutch assembly 202 shown in the third view 400, the first keys 258 are extending along the first key axes 442 to be extracted from the shaft 212 and engage with the first gear 214.

Each of the sleeves 274a, 276a, 274b, 276b, 274c, and 276c may have openings via which the rod 246 and more specifically the cam-shaped section 294 may be translated through. For example, the first sleeve 274a comprises a first opening 452a. The second sleeve 276a comprises a second opening 454a. The third sleeve 274b comprises a third opening 452b. The fourth sleeve 276b comprises a fourth opening 454b. The fifth sleeve 274c comprises a fifth opening 452c. The sixth sleeve 276c comprises a sixth opening 454c. Additionally the first hard stop 270 has a seventh opening 458 and the second hard stop 272 has an eighth opening 460 via which the which the rod 246 and more specifically the cam-shaped section 294 may be translated through.

Each of the sleeves 274a, 276a, 274b, 276b, 274c, and 276c has at least protrusion that extend radially around the respective openings of the sleeves. For example, the first sleeve 274a comprises a first protrusion 462a curving radially around the first opening 452a. The second sleeve 276a comprises a second protrusion 464a curving radially around the second opening 454a. The third sleeve 274b comprises a third protrusion 462b curving radially around the third opening 452b. The fourth sleeve 276b comprises a fourth protrusion 464b curving radially around the fourth opening 454b. The fifth sleeve 274c comprises a fifth protrusion 462c curving radially around the fifth opening 452c. The sixth sleeve 276c comprises a sixth protrusion 464c curving radially around sixth opening 454c.

Each of the first keys 258 may be contacted by and sandwiched between the first protrusion 462a and the second protrusion 464a, reducing the first keys 258 from translating or becoming extracted along the first key axes 442. Contact by the cam-shaped section 294 to the first keys 258 may spread the first protrusion 462a and the second protrusion 464a axially, allowing for translation of the first keys 258. The first and second protrusions 462a, 464a may be fitted to volumes and be cradled by features of the first keys 258. Each of the second keys 260 may be contacted by and sandwiched between the third protrusion 462b and the fourth protrusion 464b, reducing the second keys 260 from translating or becoming extracted along the second key axes 444. Contact by the cam-shaped section 294 to the second keys 260 may spread the third protrusion 462b and the fourth protrusion 464b, allowing for translation of the second keys 260. The third and fourth protrusions 462b, 464b may be fitted to volumes and be cradled by features of the second keys 260. Each of the third keys 262 may be contacted by and sandwiched between the fifth protrusion 462c and the sixth protrusion 464c, reducing the third keys 262 from translating or becoming extracted along the third key axes 446. Contact by the cam-shaped section 294 to the third keys 262 may spread the fifth protrusion 462c and the sixth protrusion 464c, allowing for translation of the third keys 262.

When fit to features of the first keys 258, the first protrusion 462a and the second protrusion 464a may reduce self-locking of the first keys 258 to the first gear 214 or the first pass-through holes 252. When fit to features of the second keys 260, the third protrusion 462b and the fourth protrusion 464b may reduce self-locking of the second keys 260 to the second gear 216 or the second pass-through holes 254. When fit to features of the third keys 262, the fifth protrusion 462c and the sixth protrusion 464c may be fit to features of the third keys 262 may reduce self-locking of the third keys 262 to the third gear 218 or the third pass-through holes 256.

Each set of adjacent gears of the gears positioned along the shaft 212 has an axial clearance less than 10% a face width of the adjacent gears, more specifically the gear of the adjacent gear with the smallest diameter. The axial clearance between adjacent gears is parallel with the axis 210.

For example, there is a first axial clearance 472 between the first gear 214 and the second gear 216. Likewise, there is a second axial clearance 474 between the second gear 216 and the third gear 218. The first gear 214 has a first face width 482. The second gear 216 has a second face width 484. The third gear 218 has a third face width 486. The distance of the first axial clearance 472 may be less than 10% the first face width 482 and the second face width 484. The distance of the second axial clearance 474 may be less than 10% the second face width 484 and the third face width 486.

Dimensions of clearances between the gears 214, 216, 218, including the first axial clearance 472 and the second axial clearance 474, may be arranged in such a way with the keys and sleeves of the dog clutch assembly 202, such as to avoid locking the keys with more one gear of the gears 214, 216, 218, and/or other gears of the dog clutch assembly 202 at a time. Additionally, dimensions of clearances between the keys, such as clearances between the first keys 258, the second keys 260, and the third keys 262; and dimensions for clearances between and lengths of the sleeves, such as clearances between and lengths of the first sleeve 274a, the second sleeve 276a, the third sleeve 274b, the fourth sleeve 276b, the fifth sleeve 274c, and the sixth sleeve 276c, may be arranged in such a way as to avoid locking the keys to more than one gear of the dog clutch assembly 202 at a time. The arrangement of the gears 214, 216, 218; the keys 258, 260, 262; and the sleeves 274a, 276a, 274b, 276b, 274c, 276c may avoid coupling more than one gear to the shaft 212 at a time.

Turning briefly to FIG. 12, it shows a twelfth view 1200 of the first gear 214. However, it is to be appreciated that features of the assembly including the second gear 216 and the third gear 218 share similar features that may be proportional to the features shown for the first gear 214.

The first gear 214 may have a first surface that is an outer surface, referred to herein as an outer surface 1222. The outer surface 1222 curves radially around the first gear 214. The outer surface is a pitch surface of the first gear 214.

The first gear 214 includes an opening 932 and a second surface that is an inner surface, the second surface referred to herein as an inner surface 934. The inner surface 934 curves radially around the opening 932. The first recesses 264 extend radially outward into the material of the first gear 214 from the inner surface 934. The inner surface 934 and the first recesses 264 define the shape and volume of the opening 932. The opening 932 and the inner surface 934 may be centered radially around the axis 210. The inner surface 934 is partially cylindrical in shape with the plurality of the first recesses 264 breaking up cylindrical curvature of the inner surface 934.

The first gear 214 may also have a third surface 1224 and a fourth surface 1226 that are ring like in shape and normal to the axis 210. The third surface 1224 may be flat and extend in a radial direction, with the third surface 1224 extending radially inward from the outer surface 1222. The third surface 1224 may be contiguous with the outer surface 1222. The fourth surface 1226 may be flat and ring like in shape with areas of the ring shape removed via the first recesses 264. The fourth surface 1226 may extend in a radial direction from the inner surface 934 and the first recesses 264. Sandwiched radially between the third surface 1224 and the fourth surface 1226 is a groove 1232. The groove 1232 may curve radially about the fourth surface 1226 and the opening 932.

Turning to FIG. 5A, it shows a fourth view 500 of the dog clutch assembly 202. The fourth view 500 is a side and sectional view of the dog clutch assembly 202. The FIG. 5A shows an area 504 enclosed by a plurality of dashed lines. Another view may be taken on the area 504. The fourth view 500 is taken on the area 410 of FIG. 4. FIG. 5A shows the dog clutch assembly 202 configured such that the rod 246 is in a first position. At the first position of FIG. 5A, the cam-shaped section 294 is brought to a first point 506.

The fourth view 500 shows a plurality of points along the axis 210, including the first point 506, a second point 508, and a third point 510 that the cam-shaped section 294 may be translated to. The first set of the first keys 258 may be positioned radially around the first point 506 and the second keys 260 may be positioned radially around the second point 508. The third point 510 is neutral point that is axially between and approximately equidistant from the first point 506 and the second point 508. The third point 510 therein may be axially between and approximately equidistant from the first keys 258 and the second keys 260.

The cam-shaped section 294 may have portions that are a first diameter 520 and a second diameter 522. The first diameter 520 is a minimum diameter and the second diameter 522 is a maximum diameter of the cam-shaped section 294. The first diameter 520 is below a first threshold of distance, such that the cam-shaped section 294 may be positioned radially inward from the first set of the first keys 258, the second set of the second keys 260, or the third set of the third keys 262 without contact. The second diameter 522 is above a second threshold of distance, such that the cam-shaped section 294 contacts and compels the first set of the first keys 258, the second set of the second keys 260, or the third set of the third keys 262 to extend from their respective pass-through holes on the shaft 212. The first set of the first keys 258, the second set of the second keys 260, or the third set of the third keys 262 toward and into recesses of first gear 214, the second gear 216, or the third gear 218, respectively.

The first sleeve 274a and the second sleeve 276a may be separated by a first clearance 512. The first keys 258 may be sandwiched axially between the first sleeve 274a and the second sleeve 276a in the first clearance 512. Likewise, the third sleeve 274b and the fourth sleeve 276b are separated by a second clearance 514. The second keys 260 may be sandwiched axially between the third sleeve 274b and the fourth sleeve 276b in the second clearance 514. The fourth sleeve 276b and the fifth sleeve 274c may be separated by a third clearance 516. Additionally, there may be a fourth clearance 518 between the second gear 216 and each key of the second keys 260. More specifically, the fourth clearance 518 is between the second keys 260 and contact surfaces of the second recesses 266. The first clearance 512, the second clearance 514, and the third clearance are axial clearances parallel with the axis 210. The fourth clearance 518 is a radial clearance in a radial direction between the second keys 260 and the second gear 216. As the second keys 260 are translated radially inward, the fourth clearance 518 increases in distance.

The third sleeve 274b and the fourth sleeve 276b abut, rest against, and press features of the second keys 260, locking and reducing a distance the second keys 260 may be extended toward the second recesses 266 without a deliberate force greater than a threshold of force for spreading the third sleeve 274b and the fourth sleeve 276b. Contact between the sliding keys and the cam-shaped section 294 may provide a force greater than the first threshold to spread the sliding sleeves apart. For example, contact between the cam-shaped section 294 and first keys 258 may spread apart the first sleeve 274a and the second sleeve 276a, or contact between the cam-shaped section 294 and second keys 260 may spread apart the third sleeve 274b and the fourth sleeve 276b.

In the first position, the cam-shaped section 294 contacts the first keys 258 and has spread apart the first sleeve 274a and the second sleeve 276a. The spreading apart of the first sleeve 274a and the second sleeve 276a increases the size of the first clearance 512.

In the first position, cam-shaped section 294 is positioned such that a first portion with the second diameter 522 is at the first point 506 and in contact with the first keys 258, pressing the first keys 258 radially outward. Increasing the diameter of cam-shaped section 294 at the first point 506 compels the first keys 258 to slide a distance further radially outward. Additionally, increasing the diameter of the cam-shaped section 294 at the first point 506 compels the first sleeve 274a and the third sleeve 274b to slide further apart due to pressing from the first keys 258, expanding the first clearance 512. The second diameter 522 is the maximum diameter, and therein the first keys 258 may slide radially outward to be extracted at a maximum distance radially from the shaft 212. The first keys 258 are pressed into contact with the first recesses 264, engaging to selectively couple and lock the first gear 214 with the shaft 212. The abutment of the first keys 258 with contact surfaces of the first recesses 264 engages with first gear 214, selectively coupling the first gear 214 to the shaft 212. Due to contact, a clearance is lacking or infinitesimally small between the first keys 258 and the first gear 214. Additionally, the first clearance 512 is expanded to a maximum distance due to the second diameter 522 intersecting first point 506, and due to the first keys 258 being extracted to a maximum distance from the axis 210 while pressing upon the first sleeve 274a and the second sleeve 276a.

An axial clearance between two sliding sleeves of a same set is a distance, where the distance is such that when a set of keys between the two sliding sleeves are extended, the axial clearance and at least a sliding sleeve of the same set impedes extension of other sets of keys between other sets of sliding sleeves. The axial clearance between two sliding sleeves may therein realize an interlock for the dog clutch assembly 202, preventing more than a set of keys from being extracted from the shaft 212. Contact between sleeves prevents extension of the keys greater than a threshold of distance radially outward at a minimum axial clearance.

For example, in the first position of FIG. 5A, the first clearance 512 is expanded, causing second sleeve 276a to abut the third sleeve 274b. The second sleeve 276a and second spring 282 abutting and pressing against the third sleeve 274b, reduces translation of the third sleeve 274b in an axial direction away from the second keys 260. The third spring 284 abutting and pressing against the fourth sleeve 276b and lack of contact between the cam-shaped section 294 and second keys 260, reduces translation of the fourth sleeve 276b in an axial direction away from the second keys 260. The second clearance 514 may therein be at a minimum distance, and the third sleeve 274b and fourth sleeve 276b may impede radial translation outward and self-extraction of the second keys 260. Likewise, the third clearance 516 may be at a maximum distance, such that the fifth sleeve 274c abuts the third keys 262. The abutting and pressing of the third spring 284 against the fifth sleeve 274c and the lack of contact between the cam-shaped section 294 and third keys 262 reduces translation of the fifth sleeve 274c in an axial direction away from the third keys 262.

It is to be appreciated, that the rod 246 may be configured to be positioned at different axial positions, where the cam-shaped section 294 may be radially inward from another gear and in contact with other sets of keys. For example, for a first alternative position, the cam-shaped section 294 may be positioned radially inward from and in contact with the second keys 260, pressing the second keys 260 radially outward. The second keys 260 may be pressed into contact with the second recesses 266 to selectively couple and lock the second gear 216 with the shaft 212. In such arrangements, the third sleeve 274b and second spring 282 abut the second sleeve 276a, reducing translation of the second sleeve 276a in an axial direction away from the first keys 258. The first sleeve 274a and second sleeve 276a may impede radial translation outward and self-extraction of the first keys 258. Likewise, the third sleeve 274b and fourth sleeve 276b and the third spring 284 may abut the fifth sleeve 274c reducing translation of the fifth sleeve 274c in an axial direction away from the third keys 262. The fifth sleeve 274c and sixth sleeve 276c may impede radial translation outward and self-extraction of the third keys 262.

Further, for a second alternative position, the cam-shaped section 294 may be positioned radially inward and in contact with the third keys 262, pressing the third keys 262 radially outward. The third keys 262 may be pressed into contact with the third recesses 268 to selectively couple and lock the third gear 218 with the shaft 212. In such arrangements, the fifth sleeve 274c and the third spring 284 may abut the fourth sleeve 276b reducing translation of the fourth sleeve 276b in an axial direction away from the second keys 260. The third sleeve 274b and fourth sleeve 276b may impede radial translation outward and self-extraction of the second keys 260.

Turning to FIG. 5B, it shows the fourth view 500 of the of the dog clutch assembly 202. FIG. 5B shows the dog clutch assembly 202 may be configured such that the rod 246 is in a second position. At the second position, the cam-shaped section 294 is translated away from the first point 506 compared to the first position of FIG. 5A. At the second position the first portion of cam-shaped section 294 with the second diameter 522 is at a point along the axis 210 between the first point 506 and the third point 510.

At the second position, a second portion of the cam-shaped section 294 remains radially inward from and in contact with the first keys 258. The second portion has a diameter that is an intermediate diameter 546. The intermediate diameter 546 is smaller in distance second diameter 522 and greater in distance than the first diameter 520. The decreased diameter for cam-shaped section 294 and the pressing of the first sleeve 274a and the second sleeve 276a may compel the first keys 258 to translate in a radially inward direction toward the axis 210. The first keys 258 are translated radially inward in the second position compared to the first position of FIG. 5A.

The reduction of the diameter for a portion of the cam-shaped section 294 in contact with the first keys 258, may allow the first sleeve 274a to be translated in an axial direction away from the first hard stop 270. Likewise, second sleeve 276a may be translated axially away from the third sleeve 274b. The translation of the first sleeve 274a and the second sleeve 276a toward the first point 506 may decrease the distance of the first clearance 512.

A fifth clearance 534 may be created between the first sleeve 274a and the first hard stop 270. The fifth clearance 534 increases in distance the further the first sleeve 274a is from the first hard stop 270. A sixth clearance 536 may be created between the second sleeve 276a and the third sleeve 274b. The sixth clearance 536 increases in distance the further the second sleeve 276a is from the third sleeve 274b. The fifth clearance 534 and the sixth clearance 536 are axial clearances that may be parallel with the axis 210.

The translation of the first keys 258 radially inward may create a seventh clearance 538 between the first gear 214 and each key of the first keys 258. More specifically, the seventh clearance 538 is radially between the first keys 258 and one or more contact surfaces of the first recesses 264. The seventh clearance 538 is a radial clearance in a radial direction between the first keys 258 and the first gear 214. As the first keys 258 are translated radially inward, the seventh clearance 538 increases in distance. At the second position the seventh clearance 538 is smaller in distance than the fourth clearance 518.

It is to be appreciated that keys, such as the first keys 258, the second keys 260, and the third keys 262 may be reduced from retracting during transfer of torque to and rotation of the shaft 212. If transmission of torque to and rotation of the shaft 212 persists, then a set of sliding keys selectively coupling a gear to the shaft 212 remain coupled to their respective gear recesses, even after the cam-shaped section 294 has been removed from an engaged position with the keys. Likewise, each of the locked sleeves abuts adjacent sleeves of other sets reducing formation of a clearance therebetween. For example, if the shaft 212 were rotating and the rod 246 were in the second position, the first keys 258 would remain extended and there would be no formation of the seventh clearance 538. Likewise, the first sleeve 274a may abut the first hard stop 270 reducing formation of the fifth clearance 534. Further the second sleeve 276a may abut the third sleeve 274b reducing formation of the sixth clearance 536.

This realization of the interlocking feature, in turn, keeps an adjacent set of keys mechanically locked, reducing and preventing the cam-shaped section 294 from compelling adjacent keys to the locked keys from moving radially outward upon contact. The interlock feature, also reducing the rod 246 from engaging the next gear or any other gear. In such cases, a locked sleeve that the locked keys are sandwiched between obstructs the movement of the rod 246 along the axis 210 from contacting the adjacent set of keys.

Turning to FIG. 5C, it shows the fourth view 500 of the of the assembly 202. FIG. 5C shows the assembly 202 may be configured such that the rod 246 is in a third position. At the third position, the cam-shaped section 294 is translated further away in an axial direction from the first point 506 compared to the second position of FIG. 5B. In the third position, the first portion of the cam-shaped section 294 with the second diameter 522 is at the third point 510, and the cam-shaped section 294 is at a neutral position out of contact with the first keys 258, the second keys 260, and the third keys 262.

The first keys 258 and the second keys 260 may be separated by a distance 542. The distance 542 is an axial distance parallel with the axis 210. Additionally, the cam-shaped section 294 is a length 552. When the rod 246 is parallel or co-axial with the axis 210, the length 552 may be parallel with the axis 210. The length 552 is such that the cam-shaped section 294 is out of surface sharing contact with the first keys 258 or the second keys 260. For a first example, the distance 542 is greater than length 552.

At the third position, the cam-shaped section 294 is fully out of contact with the first keys 258, allowing for the first keys 258 to be retracted. The first sleeve 274a and the second sleeve 276a may press upon and reduce translation of the first keys 258 radially outward. The first sleeve 274a and the second sleeve 276a abut, rest against, and press features of the first keys 258, locking and reducing extension of the first keys 258 toward the first recesses 264 without a deliberate force greater than the threshold of force for spreading the first sleeve 274a and the second sleeve 276a. The first sleeve 274a and the second sleeve 276a are reduced from translating closer to the first point 506 in an axial direction via the first keys 258. The first clearance 512 may therein be decreased to a minimum distance at the third position. The first clearance 512 and second clearance 514 may be approximately the same distance at the third position.

The first sleeve 274a may be translated axially further away from the first hard stop 270 compared to the second position, such as at a maximum distance from the first hard stop 270. The fifth clearance 534 may therein be increased in distance compared to the second position, such as to a maximum distance. Likewise, second sleeve 276a may be translated axially further away from the third sleeve 274b compared to when the rod is at the second position, such as a first maximum distance from the fourth sleeve 276b. The sixth clearance 536 may therein be increased in distance, such as a second maximum distance. The fifth clearance 534 and the sixth clearance 536 may be approximately equal in distance.

It is to be appreciated, that the cam-shaped section 294 may be positioned at other neutral positions besides the third position of FIG. 5C. The other neutral positions are between other sets of keys, such as a neutral position between the second keys 260 and third keys 262. The other neutral positions have a point along the axis 210 that is equidistant in distance from two sets of keys on opposite sides of the neutral position. The first portion of the cam-shaped section 294 with the second diameter 522 may be translated to the point, such that the cam-shaped section 294 is in the other neutral position between the sets of keys. When translated to the other neutral position the cam-shaped section 294 is out of contact with either set of keys.

Turning to FIG. 5D, it shows the fourth view 500 of the of the dog clutch assembly 202. FIG. 5D shows the dog clutch assembly 202 may be configured such that the rod 246 is in a fourth position. At the fourth position, the cam-shaped section 294 is translated further away in an axial direction from the first point 506 and toward the second point 508 compared to when the rod 246 is at the third position of FIG. 5C. In the fourth position, the first portion of the cam-shaped section 294 with the second diameter 522 is axially between the second point 508 and the third point 510, and the cam-shaped section 294 contacts with the second keys 260. The FIG. 5D shows an area 562 enclosed by a plurality of dashed lines. Another view may be taken on the area 562.

At the fourth position, the cam-shaped section 294 is positioned such that a third portion of the cam-shaped section 294 that is the first diameter 520 is at the second point 508. The third portion of the cam-shaped section 294 is radially inward of the second keys 260 but out of contact with the second keys 260. A fourth portion of the cam-shaped section 294 may contact the second keys 260 at a point axially between the second point 508 and the third point 510. The fourth portion has a second intermediate diameter 572, where the second intermediate diameter 572 is smaller in distance second diameter 522 and greater in distance than the first diameter 520.

Contact with the cam-shaped section 294 to the second keys 260, presses and compels the second keys 260 to translate radially outward. As the diameter increase for cam-shaped section 294 in contact with the second keys 260 increase, the second keys 260 may be pressed upon by the cam-shaped section 294 and compelled to translate further in a radially outward direction. The second keys 260 may press upon and spread apart the third sleeve 274b and the fourth sleeve 276b. The spreading of the third sleeve 274b and the fourth sleeve 276b increases the size of the second clearance 514 compared to when the rod 246 is at the third position. The second clearance 514 may be increased in size to be greater than the first clearance 512. The third sleeve 274b may be translated axially toward the second sleeve 276a, decreasing the size of the sixth clearance 536 compared to when the rod 246 is at the third position. The fourth sleeve 276b may be translated axially toward the fifth sleeve 274c, decreasing the size of the third clearance 516 compared to when the rod 246 is at the third position. The second keys 260 may be translated radially outward, decreasing the fourth clearance 518 to be less than the seventh clearance 538.

At the fourth position, the first clearance 512 and the fifth clearance 534 may remain unchanged in size compared to when the rod 246 is at the third position.

It is to be appreciated that keys, such as the first keys 258, the second keys 260, and the third keys 262 may be reduced from retracting during transfer of torque to and rotation of the shaft 212. If transmission of torque to and rotation of the shaft 212 persists, then a set of sliding keys selectively coupling a gear to the shaft 212 remain coupled to their respective gear recesses, even after the cam-shaped section 294 has been removed from an engaged position with the keys. Likewise, each of the locked sleeves abuts adjacent sleeves of other sets reducing formation of a clearance therebetween. Further the lack of clearances reduces the adjacent sleeve from being spread apart via pressing. Therein, the lack of clearances between adjacent sleeves and the sleeves of the keys locked with the gear reduces radially outward movement of adjacent keys to the locked keys upon contact with the cam-shaped section. Further, the sleeve locked in place by another sleeve of the locked keys and the adjacent keys obstruct the forward movement of the rod. For example, if the shaft 212 were rotating and the rod 246 were contacting the second keys 260, the first keys 258 would remain extended and there would be no formation of the seventh clearance 538. Likewise, the first sleeve 274a may abut the first hard stop 270 reducing formation of the fifth clearance 534. Further the second sleeve 276a may abut the third sleeve 274b reducing formation of the sixth clearance 536. The abutment of the second sleeve 276a with the third sleeve 274b may reduce the spreading of the third sleeve 274b in an axial direction away from the second keys 260, therein locking the third sleeve 274b. Reducing translation of the third sleeve 274b reduces sliding of the second keys 260 radially outward therein. Upon contact with the second keys 260, the second keys 260 and the third sleeve 274b may therein obstruct axial movement of the rod 246 along axis 210. For this example, the second keys 260 and the third sleeve 274b may obstruct forward movement of the rod 246 in an axial direction toward the first side 204. The rod 246 may be reduced from moving to the fourth position of FIG. 5D upon contact with the second keys 260.

It is to be appreciated that the rod 246 may be translated to a fifth position. In the fifth position, the cam-shaped section 294 is positioned such that the first portion with the second diameter 522 is at the second point 508 and in contact with the first keys 258, pressing the second keys 260 radially outward. Increasing the diameter of cam-shaped section 294 at the second point 508 compels the second keys 260 to slide a distance further radially outward. Additionally, increasing the diameter of the cam-shaped section 294 at the second point 508 compels the third sleeve 274b and the fourth sleeve 276b to slide further apart due to pressing from the second keys 260, expanding the second clearance 514. The second keys 260 may slide radially outward to be extracted at a maximum distance radially from the shaft 212. The second keys 260 are pressed into contact with the second recesses 266. The abutment of the second keys 260 with contact surfaces of the second recesses 266 realizes engagement with second gear 216, selectively coupling the second gear 216 to the shaft 212. Due to contact, the fourth clearance 518 is lacking or infinitesimally small between the second keys 260 and the second gear 216. Additionally, the second clearance 514 is expanded to a maximum distance due to the second keys 260 being extracted to a maximum distance from the axis 210 while pressing upon the third sleeve 274b and the fourth sleeve 276b.

Turning to FIG. 6, it shows a fifth view 600 of the of the dog clutch assembly 202. The fifth view 600 is a side and sectional view of the dog clutch assembly 202. The fifth view 600 shows the dog clutch assembly 202 configured such that the rod 246 is in the first position of FIG. 5A, where the cam-shaped section 294 contacts the first keys 258 via the second portion of the cam-shaped section 294 of the second diameter 522. The fifth view 600 is taken on the area 504 of FIG. 5A.

Each of the keys 258, 260, 262 may have a head and a base. The heads of the keys 258, 260, 262 may be prismatic in shape. The bases of the keys 258, 260, 262 may be smooth and rounded in shape, comprising a sectioned frustoconical shape and a sectioned cylindrical shape. The sectioned frustoconical shape is a slice of a structure with a frustoconical volume and outer surface area. The sectioned cylindrical shape is a slice of a structure with a cylindrical volume and outer surface area. For example, each of the bases may be more frustoconical in shape closer to the head of the respective key comprising the base. Each base and head of a key are connected and physically coupled. Each of the keys may have recesses, such as notches, for the cam-shaped component of the cam-shaped section 294 and features of one or more of the sleeves 274a, 276a, 274b, 276b, 274c, and 276c to fit to and abut. Additionally, the bases of the keys may be roots having a dove tail shape.

For example, each of the first keys 258 may have a first head 632a and a first base 634a. Likewise, each of the second keys 260 may have a second head 632b and a second base 634b. The first head 632a and the second head 632b may be symmetrical. Likewise, the first base 634a and the second base 634b may be symmetrical. For example, the first head 632a of each of the first keys 258 may be translated into a recess of the first recesses 264 to abut and engage with the first gear 214.

Each of the first keys 258 may have a first notch 642a, and each of the second keys 260 may have a second notch 642b. The first and second notches 642a, 642b may depress into the first base 634a, and the second base 634b, respectively, and curve in a direction toward the first head 632a and the second head 632b, respectively.

Each of the first keys 258 may have a third notch 644a and a fourth notch 646a. The third and fourth notches 644a, 646a may depress into the first base 634a and in a direction toward the first head 632a. The third notch 644a and the fourth notch 646a are between the first head 632a and the first base 634a of each of the first keys 258. Sleeves, such as the first sleeve 274a and the second sleeve 276a may be fit to the third notch 644a and the fourth notch 646a, respectively, such that surfaces of the sleeves 274a, 276a are cradled and contacted by the surfaces of the first head 632a and first base 634a around the third notch 644a and the fourth notch 646a. More specifically, the first protrusion 462a may be fit to the third notch 644a and the second protrusion 464a may be fit to the fourth notch 646a, such that the second head 632b and second base 634b cradle and contact the third protrusion 462b and the fourth protrusion 464b. When cradled and contacted, the first sleeve 274a and the second sleeve 276a may lock each of the first keys 258 reducing translation along the first key axes 442. The third notch 644a and the fourth notch 646a give the first base 634a a dovetail shape, where two symmetric inclined planes are on opposite sides of the first base 634a and each incline plane cradles the volume of the third notch 644a or the fourth notch 646a.

Each of the first keys 258 may have a fifth notch 644b and a sixth notch 646b. The fifth notch 644b and the sixth notch 646b are between the second head 632b and the second base 634b of each of each of the second keys 260. The fifth and sixth notches 644b, 646b may depress into second base 634b and in a direction toward the second head 632b. Sleeves, such as the third sleeve 274b and the fourth sleeve 276b may be fit to the fifth notch 644b and the sixth notch 646b, respectively, such that surfaces of the sleeves 274b, 276b are cradled and contacted by the surfaces of the second head 632b and second base 634b around the fifth notch 644b and the sixth notch 646b. More specifically, the third protrusion 462b may be fit to the fifth notch 644b and the fourth protrusion 464b may be fit to the sixth notch 646b, such that the second head 632b and second base 634b cradle and contact the third protrusion 462b and the fourth protrusion 464b. When cradled and contacted, the first sleeve 274a and the second sleeve 276a may lock each of the second keys 260 reducing translation along the second key axes 444. The fifth notch 644b and the sixth notch 646b give the second base 634b a dovetail shape, where two symmetric inclined planes are on opposite sides of the second base 634b and each incline plane cradles the volume of the fifth notch 644b or the sixth notch 646b.

The notches of each of the keys, including the notches 644a, 646a, 644b, and 646b may each have surfaces that incline and extend at an angle 662. A protrusion, such as the protrusions 462a, 464a, 462b, and/or 464b, may slide along the surfaces extending at angle 662 into or out of the notches 644a, 646a, 644b, and/or 646b, respectively. The notches of each of the keys, including the notches 644a, 646a, 644b, and 646b, may extend a distance 664 in an axial direction into their respective keys. The distance 664 may be approximately the same length as the sixth clearance 536 when fully expanded or another clearance between two adjacent sleeves of separate pairs that are un-pressed.

Turning to FIG. 7A, it shows a sixth view 700 of the of the dog clutch assembly 202. The sixth view 700 is a side and sectional view of the dog clutch assembly 202. The sixth view 700 shows the dog clutch assembly 202 configured such that the rod 246 is in the fourth position of FIG. 5D, where the cam-shaped section 294 contacts the second keys 260 via the second portion of the cam-shaped section 294 of the second diameter 522. The fifth view 600 is taken on the area 562 of FIG. 5D.

The third sleeve 274b comprises first surface 730 that is normal to the axis 210. The first surface 730 may be ring-like in shape and area, extending in a radial direction from the third opening 452b. The first surface 730 is contiguous with a surface of the third opening 452b that curves radially around the axis 210. The third protrusion 462b may include a first rounded surface 732. The first rounded surface 732 may be connected to and continuous with a second surface 734 that is partially frustoconical in shape and a third surface 735 that is partially cylindrical in shape. The second surface 734 may be radially around axis 210 and face radially inward from the third protrusion 462b. The second surface 734 may be contiguous with the surface of the third opening 452b. The third surface 735 may curve radially around the axis 210 and face radially outward from the third protrusion 462b. The third surface 735 may be connected to and contiguous with a fourth surface 736 via a first fillet 737. The fourth surface 736 may be ring like in shape and area extending in a radial direction outward from the first fillet 737. The fourth surface 736 may be connected to and contiguous with a fifth surface 738 via a first beveled edge 739. The fifth surface 738 may be cylindrical in shape and area, curving radially around the axis 210 and facing radially outward from the third sleeve 274b.

The fourth sleeve 276b comprises sixth surface 740 that normal to the axis 210. The sixth surface 740 may be ring-like in shape and area, extending in a radial direction from the fourth opening 454b. The sixth surface 740 is contiguous with a surface of the fourth opening 454b that curves radially around the axis 210. The fourth protrusion 464b may include a second rounded surface 742. The second rounded surface 742 may be connected to and continuous with a seventh surface 744 that is partially frustoconical in shape and an eighth surface 745 that is partially cylindrical in shape. The seventh surface 744 may be radially around axis 210 and face radially inward from the fourth protrusion 464b. The seventh surface 744 may be contiguous with the surface of the fourth opening 454b. The eighth surface 745 may curve radially around the axis 210 and face radially outward from the fourth protrusion 464b. The eighth surface 745 may be connected to and contiguous with a ninth surface 746 via a second fillet 747. The ninth surface 746 may be ring like in shape and area extending in a radial direction outward from the second fillet 747. The ninth surface 746 may be connected to and contiguous with a tenth surface 748 via a second beveled edge 749. The tenth surface 748 may be cylindrical in shape and area, curving radially around the axis 210 and facing radially outward from the fourth sleeve 276b.

The fifth surface 738 and the tenth surface 748 may be smooth with a low coefficient of friction. The fifth surface 738 and the tenth surface 748 may have surface sharing contact with an inner surface of the shaft 212, where the fifth surface 738 and the tenth surface 748 may slide in axial directions while contacting the inner surface.

Turning briefly to FIG. 11, it shows an eleventh view 1100 of a key 1102. The key 1102 is shown by the eleventh view 1100 separate from other components and features of the dog clutch assembly 202 of FIGS. 2-5D.

The key 1102 may comprise a head 632, a base 634, a first notch 642, a second notch 644, and a third notch 646. The key 1102 may be a key of the first keys 258, the second keys 260, the third keys 262, and/or another set of keys of the present disclosure. Therein, the head 632 may be the first head 632a and/or the second head 632b of FIG. 6. Likewise, the base 634 may be first base 634a and/or the second base 634b of FIG. 6. The first notch 642 may be the first notch 642a or the second notch 642b of FIG. 6. The second notch 644 may be the third notch 644a or the fifth notch 644b of FIG. 6. The third notch 646 may be the fourth notch 646a or the sixth notch 646b of FIG. 6.

The base 634 has a first key surface 1116, a second key surface 1118. The first key surface 1116 and the second key surface 1118 may be connected to and continuous with a third key surface 1119 that cradles the first notch 642. The first key surface 1116 and the second key surface 1118 may be convex in shape curving both outward away from and inward toward the first notch 642. Likewise, the first key surface 1116 and second key surface 1118 may curve in a radially inward direction, such as radially inward toward the axis 210 of FIGS. 2-6 and FIGS. 9-10. The first key surface 1116, the second key surface 1118, and/or the third key surface 1119 may have surface sharing contact with the cam-shaped section 294 of FIGS. 2-7A.

The base 634 may include a fourth key surface 1120 and a fifth key surface 1122 that may each be inclined at the angle 662 from the second notch 644 and the third notch 646, respectively. The fourth key surface 1120 and the fifth key surface 1122 may be the first incline plane and the second incline plane of the base 634. The fourth key surface 1120 may therein be a first inclined surface for a sleeve to contact and slide along, and the fifth key surface 1122 may therein be a second inclined surface for another sleeve to contact and slide along. The fourth key surface 1120 and the fifth key surface 1122 extend from the base 634 and to the head 632. The fourth key surface 1120 and the fifth key surface 1122 may connect to and be contiguous with the head 632. The fourth key surface 1120 and the fifth key surface 1122 may be on opposite sides of the base 634. The fourth key surface 1120 and the fifth key surface 1122 may be symmetrical and mirrored on opposite sides of the base 634. The fourth key surface 1120 may be around and cradle the second notch 644. The fifth key surface 1122 may be around and cradle the third notch 646.

The head 632 may include a sixth key surface 1124 and a seventh key surface 1126 that may be on opposite sides of the head 632. The sixth and seventh key surfaces 1124, 1126 may be flat. The head 632 may include an eighth key surface 1128. The eighth key surface 1128 is a top surface of the head 632 that may contact, abut, and lock with surfaces of a recess, such as a recess of the first recesses 264, the second recesses 266, and the third recesses 268 of FIGS. 2-5D.

The fourth key surface 1120 and the fifth key surface 1122 may have curvatures with multiple points of inflection. For example, the fourth key surface 1120 may be connected to and contiguous with the sixth key surface 1124 via a first beveled edge 1142. The fourth key surface 1120 may curve upward toward and be contiguous with the first beveled edge 1142 via a first curve 1132. Likewise, the fifth key surface 1122 may be connected to and contiguous with the seventh key surface 1126 via a second beveled edge 1144. The fifth key surface 1122 may curve upward toward and be contiguous with the second beveled edge 1144 via a second curve 1134.

The eighth key surface 1128 may be connected to and contiguous with a third beveled edge 1146. The third beveled edge 1146 may extend at an angle from and be connected to a side surface, such as a side surface 972 shown in FIG. 9 toward the eighth key surface 1128.

Returning to FIG. 7A, the third protrusion 462b may slide into and out of the fifth notch 644b while contacting the fourth key surface 1120. More specifically, the second surface 734 may contact the fourth key surface 1120. The first curve 1132 may cradle and abut the third protrusion 462b. The third surface 735 may share contact and abut the first curve 1132. The fourth surface 736 and the first fillet 737 may contact and abut the sixth key surface 1124 and the first beveled edge 1142, respectively. Likewise, the fourth protrusion 464b may slide into and out of the sixth notch 646b while contacting the fourth key surface 1120. More specifically, the seventh surface 744 may contact the fifth key surface 1122. The second curve 1134 may cradle and abut the fourth protrusion 464b. The eighth surface 745 may share contact and abut the second curve 1134. The ninth surface 746 and the second fillet 747 may contact and abut the seventh key surface 1126 and the second beveled edge 1144, respectively.

Turning to FIG. 7B, it shows the sixth view 700 of the dog clutch assembly 202 with a plurality of force vectors shown schematically as arrows.

A hydraulic force 760 may be placed on and advance the rod 246 of FIGS. 2-6, placing the cam-shaped section 294 in contact with one or more surfaces of the second keys 260. For example, the cam-shaped section 294 may contact the first key surface 1116. The hydraulic force 760 is an axial force. The hydraulic force 760 may be transferred to and press upon other components or features that contact the rod 246. The hydraulic force applied to the rod results in a force perpendicular to surfaces of keys of the dog clutch assembly 202. Upon contact between the cam-shaped section 294 and one or more keys of a set of keys, the hydraulic force 760 may be transferred to the keys of the dog clutch assembly 202. For example, the hydraulic force 760 may be transferred to the second keys 260 via the cam-shaped section 294. Due to the geometry of the surfaces involved, the hydraulic force 760 may be decomposed into both axial and radial components shown as a cam axial force component 762 and a cam radial force component 764, respectively. Additionally, each set of sleeves and their respective springs may place an axial components of force and a radial components of force on keys sandwiched therebetween. For example, the second spring 282 may place a first sleeve axial force component 766 and a first sleeve radial force component 768 on one or more of the second keys 260 via contact between the second keys 260 and the third sleeve 274b. For this or another example, the third spring 284 may place a second sleeve axial force component 770 and a second sleeve radial force component 772 on one or more of the second keys 260 via contact between the second keys 260 and the fourth sleeve 276b. Additionally there are forces placed on the keys of the dog clutch assembly 202, such as a key axial force component 774 and a key radial force component 776. The key axial force component 774 may be from contact of one or more keys of the dog clutch assembly 202 and the shaft 212, such as a force of friction. Likewise, the key radial force component 776 may be from external forces such as gravity and the contact of one or more keys of the dog clutch assembly 202 and the shaft 212. Keys of the dog clutch assembly 202 may contact the shaft 212 at their respective pass-through holes. For example, the second keys 260 may contact the shaft 212 at the second pass-through holes 254.

The cam axial force component 762 is sufficiently robust to overcome the axial component of spring forces and move the sleeves. As the distance between the sleeves on either side of the gear increases, the keys therebetween are unlocked, allowing for radial translation of the unlocked keys. Likewise, the cam radial force component 764 is sufficiently robust to overcome the radial force components placed on the keys, such as spring forces from the springs, the force of gravity, and force from contact between the keys and the shaft 212. The cam-shaped section 294 therein translates the keys radially outward upon contact. For example, the cam axial force component 762 may be greater than both the first sleeve axial force component 766 and the second sleeve axial force component 770, spreading the third sleeve 274b from the fourth sleeve 276b, increasing the size of the first clearance 512 of FIGS. 5A-5D, and compressing the second spring 282 and third spring 284. Likewise, the cam radial force component 764 may be greater than the first sleeve radial force component 768, the second sleeve radial force component 772, and the key radial force component 776, translating the second keys 260 in a radially outward direction.

Each of the keys, such as the second keys 260, may be rotationally free as represented by a curved arrow 778. Said in another way, each of the keys may rotate or pivot around a center or an axis concentric to the curved arrow 778 such as when contacted. The rotation may be in range of a one ten or a few tens of degrees out of a full 360 degrees. The rotation or other free movement of the keys from contact with the cam-shaped section 294 may cause the one or more keys to abut and lock with surfaces surrounding the slot or another pass-through hole of the shaft 212, such as the second pass-through holes 254. The rotation of the keys may concentrate contact and force at specific areas and surfaces of the pass-through holes of the shaft, such as with surfaces of the second pass-through holes 254. The contact and forces, such as the key axial force component 774 and a key radial force component 776, between the surfaces of pass-through holes and one or more keys may produce a self-locking effect, where one or more keys get stuck in their slots. To avoid a self-locking effect of the keys from rotation, the keys of the dog clutch assembly 202 may be a width 782 that is no more than three times a thickness 784 of the shaft 212. For example, each of the second keys 260 is the width 782 or a width smaller in distance. Likewise, each of the first keys 258 and the third keys 262 are the width 782 or a smaller width in distance. Further, a lever arm 786 of the cam-shaped section 294 may be less than three times the shaft thickness 784.

FIG. 9 shows an eighth view 900 of a section of dog clutch assembly 202, more specifically of shaft 212, the first gear 214, and the first keys 258. The eighth view 900 is a perspective and sectional view of the dog clutch assembly 202.

Each gear of the dog clutch assembly 202 has an opening and an inner surface of the gear may be radially around. The shaft 212 may be concentric to the opening. Likewise, the recesses of the gear may extend radially outward into the material of the gear from the inner surface.

The shaft 212 may be concentric to the opening 932. The inner surface 934 curves radially about and defines the shape of the opening 932. The first recesses 264 extend radially outward into the material of the first gear 214 from the inner surface 934. The first recesses 264 may have rectangular areas that receive the first keys 258.

The shaft 212 may have an outer surface 936 and an inner surface 938. The inner surface 938 may be cylindrical in shape and area. The pass-through holes of the shaft 212 may extend radially from the inner surface 938 to the outer surface 936. For example, the first pass-through holes 252 may extend from the inner surface 938 to the outer surface 936.

Each of the first keys 258 are shown to have the side surface 972. The side surface 972 may slide and contact the surfaces of the shaft 212 that form the shape of the first-pass through holes 252. The first keys 258 are shown partially extended into the first recesses 264, but not engaged with the first recesses 264.

FIG. 10 shows ninth view 1000 of a section of the dog clutch assembly 202, more specifically of the shaft 212, the first gear 214, the rod 246, and the first keys 258. The eighth view 900 is a front and sectional view of the dog clutch assembly 202 that is normal to the axis 210. The first keys 258 are shown partially extended into and engaged with the first recesses 264. In the ninth view, the first gear 214 may be selectively coupled to the shaft 212 via the first keys 258.

The dog clutch assembly 202 may have eight keys per set of keys, eight pass-through holes per set of holes, and eight recesses per gear. For example, the shaft 212 may have eight of the first keys 258 and eight of the first pass-through holes 252, and the first gear 214 may have eight of the first recesses 264.

In this way a dog clutch assembly of the present disclosure is shown. The dog clutch assembly may selectively couple a plurality of gears to a shaft, while reducing the selective coupling of two or more gears of the three gears to the shaft. There may be three gears that may be selectively coupled to the shaft. The shaft houses the plurality of sets of a plurality of keys via a plurality of sets of a plurality of slots. There may be three sets of keys and three sets of slots. The shaft also houses a rod with a cam-shaped section. The cam-shaped section may contact and translate a set of keys radially outward to engage with a specific gear of the three gears. The cam-shaped section is configured to reduce contact with more than one set of keys at a time.

A first method of shifting gears via a dog clutch assembly of the present disclosure, such as dog clutch assembly 202, may be illustrated using FIGS. 5A-5D.

The first method may comprise increasing hydraulic pressure to a hydraulic cylinder comprised by a shaft, such as the shaft 212 of FIGS. 2-5D. The hydraulic pressure may be increased to greater than the first pressure threshold on a side of a piston of the hydraulic cylinder that is rigidly coupled to a rod, where the rod may rigidly couple or comprise a cam or a cam-shaped section. For example, the rod may be rod 246 and the piston may be the piston 292 of FIGS. 2-5D. Hydraulic pressure may be increased between the piston 292 and the second side 206, translating the piston toward the first side 204.

After hydraulic pressure is increased above a first pressure threshold, the method continues translating a cam-shaped section of a rod toward a first point along a central axis, where a plurality of keys is arranged radially around the first point. During translation the rod is advanced in a direction away from the hydraulic cylinder. The keys are sandwiched axially between a first sleeve and a second sleeve.

It is to be appreciated that the first method may use another type of actuation system than a hydraulic actuator to translate the rod. For other examples, the rod may be translated via pure electric actuation or electro-hydraulic actuation. Said in another way, in place of the hydraulic pressure cylinder or another hydraulic actuation system, the rod may be translated via a pure electric actuation system or electrohydraulic actuation system, where the actuation system includes an electric machine to actuate the rod. For these examples, the electric machine may be an electric motor.

For an example, the rod may be the rod 246, the cam-shaped section may be the cam-shaped section 294, the plurality of keys may be the first keys 258, and the first point may be the second point 508 of FIGS. 5A-5B. Likewise, the first sleeve and the second sleeve may be the third sleeve 274b and fourth sleeve 276b respectively of FIGS. 5A-5B. The gear to be shifted via the dog clutch assembly may be the second gear 216.

Steps of the first method may differ if the cam-shaped section is translated from a neutral position or translated from a position where the cam-shaped section selectively couples another gear, referred to herein as the other gear, to the shaft. At the neutral position the cam-shaped section may be reduced from contacting any keys of all sets of keys of the dog clutch assembly. When starting from a neutral position the rod may be at a third point between the first point and a second point. The second point is a point along the axis where another set of keys, referred to herein as the other keys, are radially around. For example, when starting from the neutral position the rod may be at the third position of FIG. 5C. Alternatively, when the other gear is selectively coupled to the shaft, the rod contacts the other keys and realizes locking with other gear via the other keys. For another example, when starting from realizing locking with the other gear via the other keys, the rod may be in the first position of FIG. 5A. For these and other examples, the second point may be the first point 506 and the third point may be the third point 510 of FIGS. 5A-5D. The other keys may be the first keys 258, and the other gear may be the first gear 214.

If starting from realizing locking with the other keys with the other gear, the other gear is selectively decoupled from the shaft by translating the third portion the cam-shaped section away from the second point. The method continues reducing force to the plurality of other keys from the cam-shaped section. The reduction of force from the cam-shaped section allows a third sleeve and a fourth sleeve to press the other keys radially inward. The other keys may be pressed radially inward if no torque is transferred between the other gear and the shaft or one of plurality of gears of the dog clutch assembly. For an example, the third sleeve and the fourth sleeve may be the first sleeve 274a and the second sleeve 276a of FIGS. 5A-5D, respectively.

The method continues, determining if torque is transferred to the other gear and/or the shaft is rotating above a first threshold of rotational speed. Additionally, in a broader sense, the method determines if any gears of the dog clutch assembly transfer torque to the shaft.

Torque transferred between any gear of the dog clutch assembly that may be selectively coupled to the shaft and the shaft, may engage keys (e.g., lock keys in place), such as the other keys, in an extracted position. When the other keys are engaged and torque is transferred between the other gear, the torque prevents the retraction of the other keys. Further centrifugal forces at a great enough rotational speed of the shaft my lock the other keys in an extracted position, preventing retraction of the other keys. If the other gear is detected transmitting torque to the shaft, the other gear is synchronized with the shaft by the method, such that a differential rotational speed between the shaft and the other gear are less than a threshold of differential rotational speed. If any gear of the dog clutch assembly that may be selectively coupled to the shaft is detected transmitting torque to the shaft, the selectively coupled gear transmitting torque is synchronized with the shaft of the dog clutch assembly, such that another differential rotational speed between the shaft and the selectively coupled gear is within the threshold of differential rotational speed. At differential rotational speeds less than the threshold of differential rotational speed, approximately no torque is transferred between the other gear and the shaft, allowing for retraction of the other teeth. Likewise, at less than the threshold of differential rotational speed, approximately no torque is transferred between the selectively coupled gear and the shaft. Additionally, at differential speeds at or less than the differential rotational speed, the other gear and the shaft may rotate at approximately the same rotational speed.

The springs are sized to overcome a centrifugal force at a maximum rotational speed of the rotor. Said in another way the springs have a spring force great enough to press a set of keys radially inward via sliding sleeves the keys are therebetween when the centripetal force on the shaft is at a maximum and when a cam-shaped section, such as the cam-shaped section 294, is out of contact with the keys. The first threshold of rotational speed may be a maximum rotational speed that the shaft may be rotated at, above which may produce centripetal forces great enough to overcome the spring force of the spring. Said in another way, the shaft may be reduced from rotating at speeds above the first threshold of rotational speed. If the shaft is detected rotating above the first threshold of rotational speed, movers, such as ICEs or electric machines, that drive the shaft may reduce rotational energy, such as torque, until the shaft is detected rotating at a rotational speed below the threshold.

Practically speaking, the shaft may be rotated at or below a second threshold of rotational speed. The second threshold of speed is a second maximum rotational speed and the maximum speed at which shaft may be rotated by the movers of a vehicle, such as the engine 120, the first electric machine 124, and the second electric machine 126 of FIG. 1. The movers may experience undesired degradation upon rotating the shaft at rotational speeds greater than the second threshold of rotational speed. The second threshold of rotational speed is less than the first threshold of rotational speed by a good margin of speed. For example, the second threshold of rotational speed is at least less than first threshold of rotational speed subtracted by 5% of the first threshold of rotational speed.

The sizing and spring force of the springs, the geometries of the sleeves, and the interlock feature they provide to the dog clutch assembly may prevent double engagement of the dog clutch. During double engagement two sets of keys, such as the keys and other keys, engage two idler gear, such as the gear and the other gear, on the same shaft. During double engagement, the shaft locks reducing rotation of the shaft and causing the vehicle axis to which the transmission is connected to suddenly stop. The arrangement of the springs and sleeves realizes an interlock, such that only one set of keys of the plurality of keys may extend radially greater than the threshold of distance. Further, the forces from the springs are great enough to prevent extraction and reduce the radially outward translation of the keys from centripetal forces at the maximum rotational speed (e.g., the first threshold of rotational speed). Said in another way, when keys are out of contact with a cam or cam-shaped section, a set of extracted keys are reduced or prevented outright from extracting or extending radially outward when the shaft and keys experience centripetal forces less than or equal to a maximum centripetal force placed on the shaft at the first threshold of rotational speed.

If the shaft does not receive torque from any gear of the dog clutch assembly, such as the other gear, and experiences rotation below the first threshold of rotational speed, the method continues by retracting the other keys from a plurality of other recesses of the another gear. The method continues retracting the other keys toward a plurality of other pass-through holes. Once the cam-shaped section is out of contact with the other keys, the first method continues, translating the cam-shaped section to the neutral position. The third sleeve or fourth sleeve may therein be translated axially away from least one of the first sleeve or the second sleeve creating a clearance therebetween.

After starting translation from the neutral position or moving the cam-shaped section to a neutral position, the first method continues by translating a first portion of the cam-shaped section to the first point, where the first portion is a first diameter that is a distance such as to be radially inward from the keys.

Upon contact with the keys, the method may differ depending on if torque is transferred to the first shaft and/or the shaft via the selected gear (e.g., the gear that keys are extracted toward and engaged with). If the shaft receives torque from the selected gear, the extracted set of keys may not be retracted until the selected gear stops transferring torque. The method continues by reducing the extraction of the keys via centripetal force. The centripetal force radially outward at the maximum rotational speed of the shaft is less than the radially inward force of the first sleeve or the second sleeve abutting with the third sleeve or fourth sleeve. The reduction of distance the keys may be translated radially outward and the reduction of extraction of the keys may reduce axial movement of the rod after contact between the cam-shaped section and the keys.

If the shaft receives no torque from the selected gear while rotating or there is a lack of rotation of the shaft and the selected gear, the method continues by allowing extraction of the keys via contact with the cam-shaped section. The first method continues by translating a first sleeve and a second sleeve away from keys via force from contact of the cam-shaped section. The first method continues by translating the keys radially outward through a plurality of the pass-through holes via radial force from contact with the cam-shaped section.

The first method may synchronize a first rotational speed of the shaft with a second rotational speed of the gear. The synchronization of between the shaft and gear prevents torque transfer from the gear to the shaft during translation of the keys. A prerequisite for engagement is the absence of a differential rotational speed above a threshold of differential rotational speed between the shaft and the gear to be engaged. During synchronization the differential rotational speed between the first rotational speed and the second rotational speed is reduced to below the threshold of differential rotational speed. The rotational speed of the shaft may be increased or decreased via an electric motor or another electric machine. For example, the first rotational speed of the shaft may be reduced via the electric machine to be less than the threshold difference in speed with the gear via reducing torque to the shaft from the electric machine. To synchronize the shafts a pair of electric machines may be used to synchronize the gear with the shaft. For an example, a first electric machine of the pair may drive the gear and a second electric machine of the pair may drive shaft. The pair of the electric machines may be electric motors. For an example, the pair of electric machines may be located in a P2 position of vehicle 100 of FIG. 1, where the P2 position is a position separate from the P1 and P3 positions. Additionally or alternatively, synchronization may be achieved by disconnecting the shaft and/or the gear from a source of torque, reducing the differential speed of the shaft and the gear to null and less than the threshold of differential rotational speed, and therein reducing the torque to a null torque. Once synchronization between the shaft and a gear is successfully attained, the first method may continue and the engagement proceeds. The first electric machine may be configured to selectively couple and drive each gear that may be selectively coupled with the dog clutch assembly.

The first method continues by translating the keys into a plurality of recesses of the gear. The first method continues by contacting the keys with a surface of the recesses, selectively coupling the gear to the shaft. The first method continues by translating a third portion of the cam-shaped section to the first point, where the third portion is a third diameter. The third diameter being a maximum diameter of the cam-shaped section. The third diameter may be the second diameter 522 of FIGS. 5A-5D. The first method continues by holding the third portion of the cam-shaped section at the first point, locking the keys with the gear. After holding the third portion of the cam-shaped section in place, the first method may end.

For an example of the first method, the rod 246 may selectively couple the second gear 216 to the shaft 212. The rod 246 may start the third position of FIG. 5C. The first method continues as the rod 246 is translated to a first intermediate position between the third position and the fourth position of FIG. 5D. At the first intermediate position the first portion of the cam-shaped section 294 of the first diameter 520 is positioned radially within the second keys 260. The first method continues translating the rod 246 to a second intermediate position, where a portion of the cam-shaped section of a third diameter contacts the second keys 260, the third diameter between the first diameter 520 and the second diameter 522 in distance. If a differential rotational speed between the shaft 212 and the second gear 216 is greater than or equal to the threshold of differential rotational speed, the cam-shaped section 294 may be reduced from translating further. The first method may continue by synchronizing the speed of the shaft 212 with the second gear 216 via an electric machine, such that the difference in rotational speed between the shaft 212 and the second gear 216 are below the threshold of differential rotational speed.

If the differential rotational speed between the shaft 212 and the second gear 216 is less than the threshold of differential rotational speed, and the shaft 212 experiences no rotation or rotation below the threshold of rotational speed, the cam-shaped section 294 may translate the second keys 260 in a radial direction. The threshold of differential rotational speed and the threshold of rotational speed may be different values of rotational speed. The translation of the second keys 260 radially outward may spread the third sleeve 274b from the fourth sleeve 276b. The first method continues translating the rod 246 to the fifth position described below the specification of FIG. 5D, where the second keys 260 engage with the second recesses 266.

For another example of the first method, the rod 246 may decouple the first gear 214 from the shaft 212 and selectively couple the second gear 216 to the shaft 212. The rod 246 may start at the first position of FIG. 5A. The first method continues as the rod 246 is translated to the second position. If the shaft 212 is rotating at a speed greater than the threshold of rotational speed and/or is receiving torque from the first gear 214, the distance the first keys 258 translate radially inward may be reduced. The first keys 258 may remain engaged to the first gear 214. Likewise, the second keys 260 may remain locked and reduce translation of the cam-shaped section 294, such as upon contact between the cam-shaped section 294 and the second keys 260. If the shaft 212 does not receive torque from the first gear 214, and if the shaft 212 is not rotating or rotating below the threshold of rotational speed, the first keys 258 may translate radially inward and the first sleeve 274a and the second sleeve 276a may translate axially closer together. From the second position the rod 246 may be translated to the third position. The other example of the first method may then continue following the steps of the example of the first method above.

A second method of shifting gears via a dog clutch assembly of the present disclosure, such as dog clutch assembly 202, may be illustrated using FIGS. 5A-5D.

The second method may comprise the same steps as the first method, however the second method comprises decreasing hydraulic pressure to a hydraulic cylinder comprised by a shaft, such as the shaft 212 of FIGS. 2-5D. The hydraulic pressure may be increased to greater than a second pressure threshold on the side of the piston opposite to the side described in the first method. For example, the rod is the rod 246 and the piston is the piston 292 of FIGS. 2-5D. Hydraulic pressure may be increased between the piston 292 and the first side 204, translating the piston toward the second side 206.

Additionally or alternatively, the hydraulic pressure may decrease below a third pressure threshold on the side of the piston described in the first method such that the cam-shaft is translated via a spring force of a spring to a position to lock a gear. For example, a spring may be arranged to press upon the piston, such as the piston 292, of the hydraulic cylinder and translate the piston via a spring force. The spring may be housed via a hydraulic pressure body, such as the frame 248, such as to press the piston. During translation the rod is retracted in a direction toward the hydraulic cylinder. After decreasing the hydraulic pressure below the second pressure threshold, the method continues translating a cam-shaped section of a rod toward the first point along a central axis, where the plurality of keys is arranged radially around the first point.

It is to be appreciated, that the second method may use other types of actuation systems than a hydraulic actuator to translate the rod. For the second method, the other types of actuation system may translate the rod in direction opposite to the direction the rod is translated via the first method. For other examples, the rod may be translated via pure electric actuation or electro-hydraulic actuation. Said in another way, in place of the hydraulic pressure cylinder or another hydraulic actuation system, the rod may be translated via a pure electric actuation system or electrohydraulic actuation system, where the actuation system includes an electric machine to actuate the rod. For these examples, the electric machine may be an electric motor.

The second method may follow the steps of the first method in reverse, such that a gear of the dog clutch assembly that is coupled via the first method may be decoupled via the second method and another gear that may be decoupled via the first method may be coupled via the second method. The rod may be the rod 246, the cam-shaped section may be the cam-shaped section 294, the first point may be the first point 506, the second point may be the second point 508, the plurality of keys may be the first keys 258, the plurality of other keys may be the second keys 260, the plurality of pass-through holes for the keys may be the first pass-through holes 252, the plurality of other pass-through holes for the other keys may be the second pass-through holes 254, the gear may be the first gear 214, and the other gear may be the second gear 216.

For an example of the second method, the rod 246 may selectively couple the first gear 214 to the shaft 212. The rod 246 may start at the third position of FIG. 5C. The second method continues as the rod 246 is translated to a first intermediate position between the third position and the second position of FIG. 5B. At the first intermediate position the first portion of the cam-shaped section 294 of the first diameter 520 is positioned radially within the first keys 258. The second method continues translating the rod 246 to a second intermediate position, where a portion of the cam-shaped section of a third diameter contacts the second keys, the third diameter is a distance between the first diameter 520 and the second diameter 522. If a differential rotational speed between the shaft 212 and the first gear 214 is greater than or equal to the threshold of differential rotational speed and/or torque is received by the shaft 212 from a gear of the dog clutch assembly 202, the cam-shaped section 294 may be reduced from translating further. The method may continue by synchronizing the speed of the shaft 212 with the first gear 214 via an electric machine, such that the difference in rotational speed between the shaft 212 and the first gear 214 are below the differential rotational speed threshold and/or torque is prevented from being transferred between a gear of the dog clutch assembly 202 and the shaft 212.

If the differential rotational speed between the shaft 212 and the first gear 214 is less than the threshold of differential rotational speed, no torque is transferred between a gear of the dog clutch assembly 202, and the shaft 212 experiences no rotation or rotation below the threshold of rotational speed, the cam-shaped section 294 may translate the second keys 260 in a radial direction. The threshold of differential rotational speed and the threshold of rotational speed may be different values of rotational speed. The cam-shaped section 294 may translate the first keys 258 in a radial direction radially outward and spread the first sleeve 274a from the second sleeve 276a. The first method continues translating the rod 246 to the first position of FIG. 5A, where the first keys 258 engage with the first recesses 264.

For another example of the second method, the rod 246 may decouple the second gear 216 from the shaft 212 and selectively couple the first gear 214 to the shaft 212. The rod 246 may start at the fifth position described below the specification of FIG. 5D. The second method continues as the rod 246 is translated to the fourth position of FIG. 5D. If the shaft 212 is rotating at a speed greater than the threshold of rotational speed and/or is receiving torque from the second gear 216, the distance the second keys 260 translate radially inward may be reduced. The first keys 258 may remain locked and reduce translation of the cam-shaped section 294, such as upon contact between the cam-shaped section 294 and the first keys 258. If the shaft 212 does not receive torque from the first gear 214, and if the shaft 212 is not rotating or rotating below the threshold of rotational speed, the second keys 260 may translate radially inward and the third sleeve 274b and the fourth sleeve 276b may translate axially closer together. From the fourth position the rod 246 may be translated to the third position. The other example of the second method may then continue following the steps of the example of the second method above.

A third method may utilize two or more dog clutch assemblies of the present disclosure to selectively couple to a gear and shift to different gear speeds of a transmission. The third method may use the first method and/or the second method to translate rods, select and engage a gear, and deselect and disengage another gear. The third method may select and engage a first gear to selectively couple a first dog clutch assembly, while deselecting and disengaging a second gear that may selectively couple a second dog clutch assembly. For example, referencing FIG. 1, the third method may upshift the transmission 108, transitioning transmission 108 from third speed to a fourth speed. The third speed may be selected by selecting the second gearset 156 of FIG. 1 to transmit torque from one or more movers to the wheels 114 of FIG. 1. The fourth speed may be selected by selecting the sixth gearset 164 of FIG. 1 to transmit torque from one or more movers to the wheels 114. The third method may begin by starting the vehicle 100 in the third speed, having the sixth gearset 164 selected. When the third speed is selected, the odd clutch (e.g., clutch within the drum 147 of FIG. 1 that may selectively couple with the fourth shaft 148 of FIG. 1) is closed, selectively coupling the second dog clutch assembly 145 of FIG. 1 to the drum 147. Additionally, an even clutch (e.g., the clutch within the drum 147 that may selectively couple with the third shaft 146 of FIG. 1) is open, such that the first dog clutch assembly 143 of FIG. 1 is selectively decoupled from the drum 147. The odd clutch and even clutch may be wet clutches for this example.

The third method may continue by determining if both the third speed on the odd shaft and the fourth speed on the even shaft are engage. Said in another way, the third method determines if the sixth gearset 164 of FIG. 1 is selected via second dog clutch assembly 145 and the second gearset 156 of FIG. 1 is selected via the first dog clutch assembly 143, where selecting the sixth gearset 164 selects the third speed and selecting the second gearset 156 selects the fourth speed. For an arrangement where the sixth gearset 164 is selected, the second cam of the second rod 194 of FIG. 1 is under the eleventh gear 181 of FIG. 1 and contacting a second set of the second keys 198 of FIG. 1 to engage the eleventh gear 181. For this arrangement or another arrangement where the second gearset 156 is selected, the first cam of the first rod 192 of FIG. 1 is under the third gear 173 of FIG. 1 and contacting a first set of the first keys 196 of FIG. 1 to engaged the third gear 173. The sixth gearset 164 and therein the third gear speed is selected at the start of the third method for this example.

If the third gear 173 is not engaged (e.g., the fourth speed and the second gearset 156 are not selected by the first dog clutch assembly 143), the third method may advance the first rod 192 to a position where the first cam of the first rod 192 is under the third gear 173 and contacting the first set of the first keys 196. Positioning the first cam of the first rod 192 under the third gear 173 selectively couples the third shaft 146 to the third gear 173 and selects the second gearset 156.

If the third gear 173 is engaged (e.g., the fourth speed and the second gearset 156 are selected by the first dog clutch assembly 143), the third method may hold the first rod 192 such that the first cam remains positioned under the third gear 173, keeping the third gear 173 engaged and selectively coupled to the third shaft 146.

The third method and the interlock arrangement of the first dog clutch assembly 143 prevents or reduces the engagement of the other gears that may selectively couple to the third shaft 146, such as the first gear 171, the fifth gear 175, and the seventh gear 177, when the third gear 173 is engaged. Likewise, the third method and the interlock arrangement of the second dog clutch assembly 145 prevents or reduces the engagement of the other gears that may selectively couple to the fourth shaft 148, such as the ninth gear 179, the thirteenth gear 183, and the fifteenth gear 185, when the eleventh gear 181 is engaged.

The third method continues by handing over torque from the second dog clutch assembly 145 to the first dog clutch assembly 143. During hand over of torque, the odd clutch is opened and the even clutch is closed. When the odd clutch is opened, the second dog clutch assembly 145 is decoupled from the drum 147. When the even clutch is closed, the first dog clutch assembly 143 is selectively coupled to the drum 147. The hand over of torque from the second dog clutch assembly 145 to the first dog clutch assembly 143 may take place within a time span of a few hundred milliseconds. The first cam of the first rod 192 and the second cam of the second rod 194 remain in place.

After the shifting from 3rd speed to 4th speed is completed, the method opens the odd clutch and therefore the torque of the eleventh gear 181 is reduced to nearly null. The differential speed between the eleventh gear 181 and the fourth shaft 148 may therein be below the threshold of differential speed. The third method may optionally continue, by advancing the second cam of the second rod 194 to be under another gear that may selectively couple the fourth shaft 148. Advancing the second cam beneath the other gear contacts another set of second keys 198 of the second dog clutch assembly 145 selectively couples and engages the other gear. Said in another way, the third method preselects the other gear to selectively couple the fourth shaft 148, such that the other gear is selected when hand over of torque occurs between from first dog clutch assembly 143 to the second dog clutch assembly 145. For example, the second rod 194 is moved for the second cam to advance under and preselect the thirteenth gear 183. For another example, the second rod 194 is moved for the second cam to advance under and preselect the ninth gear 179.

In this way, a plurality of methods is disclosed for a procedure to shifting gears via a dog clutch assembly comprising increasing or decreasing hydraulic pressure to a hydraulic cylinder to actuate a rod and translate a cam-shaped section of the rod into and out of contact with a plurality of keys. Contacting the keys with the cam-shaped section engages the keys with a gear to realize engagement between the keys and a plurality of recesses of the gear, wherein the gear is selectively coupled to a shaft housing the hydraulic cylinder and rod. Moving the keys out of contact with the cam-shaped section selectively decouples the gear from the shaft, disengaging coupling between the keys and the plurality of recesses.

In another interpretation, the disclosure provides support for a dog clutch assembly comprising: a hollow shaft, having a plurality of first pass-through holes and a plurality of second pass-through holes arranged radially around a central axis and extending from an outer surface to an inner surface of the hollow shaft; a first rod, the first rod housed by the hollow shaft; a first gear, the first gear arranged radially around the first pass-through holes; a second gear, the second gear arranged radially around the second pass-through holes; a plurality of first sliding keys, the first sliding keys housed by the first pass-through holes and configured to extend through the first pass-through holes and into a plurality of first recesses of the first gear; a plurality of second sliding keys, the second sliding keys housed by the second pass-through holes and configured to extend through the second pass-through holes of the shaft and into a plurality of second recesses of the second gear; a first set of first sleeves, where the first sliding keys are sandwiched axially between the first sleeves; a second set of second sleeves, where the second sliding keys are sandwiched axially between the second sleeves; and a rod housed by the shaft and configured to translate coaxially along the central axis, where the rod contacts and translates the first sliding keys into the first recesses to selectively couple the first gear to the shaft, and the rod contacts and translates the second sliding keys into the second recesses to selectively couple the second gear to the shaft. In a first example of the system, the rod comprises a cam-shaped section, where the cam-shaped section contacts the first sliding keys when translated to a first point along the central axis, and contacts the second sliding keys when translated to a second point along the central axis.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A transmission comprising:
a hollow shaft comprising at least two sets of radial pass-through holes including a first set and a second set of radial pass-through holes;
a plurality of gears arranged around the hollow shaft;
a plurality of sliding keys configured to extend through the radial pass-through holes of the hollow shaft and engage in a plurality of recesses of a selected gear to engage and couple the selected gear;
a plurality of sliding sleeves, where each of the sliding keys is interposed between two sliding sleeves, where the two sliding sleeves are spring-compressed and abut the sliding keys in such a way that only one gear is selected, therein realizing an interlock for the sliding keys; and
a rod configured to translate coaxially to and along the hollow shaft, where the rod comprises a cam-shaped section configured to actuate the plurality of sliding keys of the selected gear.

2. The transmission of claim 1, where the radial pass-through holes are slots.

3. The transmission of claim 1, where the cam-shaped section is operated via a hydraulic cylinder embodied in the hollow shaft, wherein the hydraulic cylinder changes pressure to actuate the cam-shaped section into contact and out of contact with the sliding keys.

4. The transmission of claim 3, where the rod includes a piston that hydraulic pressure presses upon to drive the rod coaxially along axis.

5. The transmission of claim 4, where the hydraulic cylinder includes a first passage, a second passage, and a frame, the first passage supplying hydraulic pressure to actuate the piston, the frame housed by the second passage, the frame positioned around and supporting the rod, the frame reducing the rod from translating along the axis past a first point and a second point along the axis.

6. The transmission of claim 1, where each set of the radial pass-through holes have geometries reducing self-locking of a respective set of sliding keys.

7. The transmission of claim 1, where the gears positioned along the hollow shaft are idler gears.

8. The transmission of claim 1, where each set of adjacent gears of the gears positioned along the hollow shaft have an axial clearance less than 10% of a face width of the adjacent gears.

9. The transmission of claim 1, where each of an axial clearance between two sliding sleeves of a same set is a distance, the distance is such that the axial clearance and at least a sliding sleeve of the same set impedes extraction of other sets of keys between other sets of other sliding sleeves.

10. The transmission of claim 1, where there is a distance between a pair of sets of sliding keys and the cam-shaped section is a length, the length is less than the distance such that the cam-shaped section is translated to a neutral position between the pair of sets where contact is reduced from the cam-shaped section with either set of sliding keys from the pair.

11. The transmission of claim 1, where each of the sliding keys has a base and a head, the base having a first inclined surface and a second inclined surface that are symmetric, mirrored, and extend in a direction toward the head.

12. The transmission of claim 11, where a first sliding sleeve abuts and rests against the first inclined surface of a sliding key and a second sliding sleeve abuts and rests against the second inclined surface of the sliding key, locking and reducing extension of the sliding key toward a recess of a gear.

13. The transmission of claim 12, where the first sliding sleeve slides away from the sliding key along the first inclined surface and the second sliding sleeve slides away from the sliding key along the second inclined surface when a radial force greater than a threshold of force extends the sliding key radially outward.

14. The transmission of claim 1, where the hollow shaft comprises a plurality of other sets of radial pass-through holes, and the sliding keys are configured to extend radially outward from each of the other sets of radial pass-through holes and into recesses of another gear.

15. A vehicle comprising:
a first mover;
a second mover;
a first shaft, where the first shaft is hollow and driven by the first mover, the first shaft including a plurality of first sliding keys and a first rod, the first sliding keys configured to extend through a plurality of first slots of the first shaft, and the first rod configured to translate coaxially along the first shaft and contact the first sliding keys to extend through the first slots;
a second shaft, where the second shaft is driven by the second mover;
a transmission, the transmission comprising a gear selection assembly, the gear selection assembly comprising a plurality of first gearsets of different ratios; and
a drive axle, the drive axle driven by the second shaft;
where each of the first gearsets of the gear selection assembly has at least a first gear and a second gear, where each first gear is configured around the first shaft such that a set of the first sliding keys extend through the first slots into a plurality of recesses of a selected first gear, engaging with the selected first gear and selectively coupling the selected first gear to the first shaft, and each second gear is rigidly coupled to the second shaft, the first gear drives the second gear, and where the first shaft drives the second shaft via a selected gearset of the first gearsets that includes the selected first gear.

16. The vehicle of claim 15, where the gear selection assembly comprises a plurality of second gearsets of different ratios; each of the second gearsets having at least a third gear and a fourth gear, with the third gear selectively coupling rotational element driven by the first mover, and the fourth gear rigidly coupled to the second shaft, and the third gear drives the fourth gear.

17. The vehicle of claim 16, where the rotational element is a third shaft, where the third shaft is hollow and includes a plurality of second sliding keys and a second rod, where the plurality of second sliding keys configured to extend through a plurality of second slots of the third shaft, and the second rod is configured to translate coaxially along the third shaft and contact the second sliding keys to extend through the second slots, and the where the third gear is configured around first shaft such that another set of the second sliding keys extend through the second slots into a plurality of other recesses of a selected third gear, engaging with the selected third gear and selectively coupling the selected third gear to the third shaft, where the third shaft drives the second shaft via another gearset of the second gearsets that includes the selected third gear.

18. The vehicle of claim 15, where the first mover and the second mover are electric machines part of an electrified driveline.

19. A method of shifting gears via a dog clutch assembly comprising:
increasing or decreasing a hydraulic pressure to a hydraulic cylinder comprised by a shaft;
actuating a rod via the hydraulic pressure;
translating a cam-shaped section of the rod toward a first point along a central axis, where a plurality of keys is arranged radially around the first point;
translating a first portion of the cam-shaped section to the first point, where the first portion is a first diameter that is a distance such as to be radially inward from the keys;
translating a second portion of the cam-shaped section to the first point, where the second portion is a second diameter to contact the keys;
translating a first sleeve and a second sleeve away from keys via force from contact of the cam-shaped section, the keys sandwiched between the first sleeve and the second sleeve;
translating the keys radially outward through a plurality of pass-through holes via radial force from contact with the cam-shaped section;
translating the keys into a plurality of recesses of a gear;
contacting the keys with a surface of the recesses, selectively coupling the gear to the shaft;
translating a third portion of the cam-shaped section to the first point, where the third portion is a third diameter being a maximum diameter of the cam-shaped section; and
holding the third portion of the cam-shaped section at the first point, locking the keys with the gear.

20. The method of claim 19, where dimensions of clearances between a plurality of gears, other dimensions of clearances between the keys and a plurality of other keys, and lengths of the first sleeve, the second sleeve, and other sleeves of the dog clutch assembly are arranged in such a way as to avoid locking the keys and the other keys with more than one gear of the plurality of gears at a time, and therein avoid selectively coupling more than one gear to the shaft, where the plurality of gears include the gear.
